(19) United States
(12) Patent Application Publication
(10) Pub. No.: US 2007/0279434 A1
(43) Pub. Date: Dec. 6, 2007

(54) Image processing device executing filtering process on graphics and method for image processing

(76) Inventors: Masahiro Fujita, Kawasaki-shi (JP); Takahiro Saito, Tokyo (JP)

Correspondence Address: SPRINKLE IP LAW GROUP, 1301 W. 25TH STREET, SUITE 408, AUSTIN, TX, 78705, US

(21) Appl. No.: 11/804,318

(22) Filed: May 17, 2007

(30) Foreign Application Priority Data
May 18, 2006 (JP) 2006-139270

(51) Int. Cl. G09G 5/00

(52) U.S. Cl. 345/611; 345/582

(57) ABSTRACT

A method for image processing includes receiving a first coordinate in first image data which is a set of a plurality of first pixels, the first coordinate corresponding to a second coordinate in second image data which is a set of a plurality of second pixels, and positional information indicative of a positional relationship among n (n is a natural number equal to or greater than 4) of the first pixels, calculating an address of the first pixels corresponding to the first coordinate on the basis of the first coordinate and the positional information, reading the first pixels using the address, and executing a filtering process on the first pixels read from the first memory to acquire a third pixel to be applied to one of the second pixels with the second coordinate. The second coordinate defines a mapping of the first pixels to one of the second pixels.

### CROSS-REFERENCE TO RELATED APPLICATIONS

This application is based upon and claims the benefit of priority from prior Japanese Patent Application No. 2006-139270, filed May 18, 2006, the entire contents of which are incorporated herein by reference.

### BACKGROUND OF THE INVENTION

1. Field of the Invention

The present invention relates to a method and device for image processing. For example, the present invention relates to a technique for filtering textures.

2. Description of the Related Art

3D graphics LSIs execute a process for applying textures to polygons (texture mapping). In this case, for more abundant expressions, a plurality of texels may be referenced for each pixel. The details of texture mapping are disclosed in, for example, Paul S. Heckbert, “Fundamentals of Texture Mapping and Image Warping (Masters Thesis)”, Report No. UCB/CSD 89/516, Computer Science Division, University of California, Berkeley, June 1989.

However, in the case of that the texture mapping is executed by the hardware, the conventional method allows only (2×2) texels to be read at a time. This significantly limits the flexibility of texel processing.

### BRIEF SUMMARY OF THE INVENTION

A method for image processing according to an aspect of the present invention includes:

receiving a first coordinate in first image data which is a set of a plurality of first pixels, the first coordinate corresponding to a second coordinate in second image data which is a set of a plurality of second pixels, the second coordinate defining a mapping of the first pixels to one of the second pixels, and positional information indicative of a positional relationship among n (n is a natural number equal to or greater than 4) of the first pixels;

calculating an address of the first pixels corresponding to the first coordinate on the basis of the first coordinate and the positional information;

reading the first pixels from a first memory using the address; and

executing a filtering process on the first pixels read from the first memory to acquire a third pixel to be applied to one of the second pixels corresponding to the second coordinate.

An image processing device according to an aspect of the present invention includes:

a first memory which holds first image data which is a set of a plurality of first pixels;

an image data acquisition unit which reads the first pixels from the first memory, the image data acquisition unit reading a plurality of the first pixels on the basis of first coordinate in the first image data corresponding to a second coordinate in second image data which is a set of a plurality of second pixels, the second coordinate defining a mapping of the first pixels to one of the second pixels, and a positional relationship among n (n is a natural number equal to or greater than 4) of the first pixels corresponding to the first coordinate; and

a filtering process unit which executes a filtering process on the first pixels read from the first memory by the image data acquisition unit to acquire a third pixel.

### BRIEF DESCRIPTION OF THE SEVERAL VIEWS OF THE DRAWING

The file of this patent contains photographs executed in color. Copies of this patent with color photographs will be provided by the Patent and Trademark Office upon request and payment of the necessary fee.

FIG. 1 is a block diagram of a graphic processor in accordance with a first embodiment of the present invention;

FIG. 2 is a conceptual diagram of a frame buffer in the graphic processor in accordance with the first embodiment of the present invention;

FIG. 3 is a conceptual diagram of the frame buffer in the graphic processor in accordance with the first embodiment of the present invention;

FIG. 4 is a conceptual diagram of a texture in the graphic processor in accordance with the first embodiment of the present invention;

FIG. 5 is a block diagram of a texture unit provided in the graphic processor in accordance with the first embodiment of the present invention;

FIG. 6 is a block diagram of a data acquisition unit provided in the graphic processor in accordance with the first embodiment of the present invention;

FIG. 7 is a flowchart of a method for image processing in accordance with the first embodiment of the present invention;

FIG. 8 is a conceptual diagram of UV coordinates showing the positions of texels acquired in a (4×1) mode of the graphic processor in accordance with the first embodiment of the present invention;

FIG. 9 is a block diagram of the data acquisition unit provided in the graphic processor in accordance with the first embodiment of the present invention, showing how coordinate calculations are made in the (4×1) mode;

FIG. 10 is a conceptual diagram of UV coordinates showing the positions of texels acquired in a (1×4) mode of the graphic processor in accordance with the first embodiment of the present invention;

FIG. 11 is a block diagram of the data acquisition unit provided in the graphic processor in accordance with the first embodiment of the present invention, showing how coordinate calculations are made in the (1×4) mode;

FIG. 12 is a conceptual diagram of UV coordinates showing the positions of texels acquired in a cross mode of the graphic processor in accordance with the first embodiment of the present invention;

FIG. 13 is a block diagram of the data acquisition unit provided in the graphic processor in accordance with the first embodiment of the present invention, showing how coordinate calculations are made in the cross mode;

FIG. 14 is a conceptual diagram of UV coordinates showing the positions of texels acquired in an RC mode of the graphic processor in accordance with the first embodiment of the present invention;

FIG. 15 is a block diagram of the data acquisition unit provided in the graphic processor in accordance with the first embodiment of the present invention, showing how coordinate calculations are made in the RC mode;

FIG. 16 is a conceptual diagram of UV coordinates showing the positions of texels acquired in a (2×2) mode of the graphic processor in accordance with the first embodiment of the present invention;

FIG. 17 is a block diagram of the data acquisition unit provided in the graphic processor in accordance with the first embodiment of the present invention, showing how coordinate calculations are made in the (2×2) mode;

FIG. 18 is a flowchart of a method for image processing in accordance with the first embodiment of the present invention, particularly showing a filtering process;

FIG. 19 is a conceptual diagram showing a filtering process;

FIG. 20 is a conceptual diagram of texture images showing how a filtering process is executed using the method for image processing in accordance with the first embodiment of the present invention;

FIG. 21 is a photograph of a texture image not subjected to a filtering process yet, showing how (4×1) filtering is executed by the method for image processing in accordance with the first embodiment of the present invention;

FIG. 22 is a photograph of a texture image subjected to (4×1) filtering, showing how (1×4) filtering is executed by the method for image processing in accordance with the first embodiment of the present invention;

FIG. 23 is a photograph of a texture image subjected to (4×4) filtering;

FIG. 24 is a block diagram of a texture unit provided in a graphic processor in accordance with a second embodiment of the present invention;

FIG. 25 is a flowchart of a method for image processing in accordance with the second embodiment of the present invention;

FIG. 26 is a block diagram of a data acquisition unit provided in the graphic processor in accordance with a second embodiment of the present invention, showing how coordinate calculations are executed in the (4×1) mode when a repetition count is 1;

FIG. 27 is a block diagram of the data acquisition unit provided in the graphic processor in accordance with the second embodiment of the present invention, showing how coordinate calculations are executed in the (4×1) mode when the repetition count is 2;

FIG. 28 is a block diagram of the data acquisition unit provided in the graphic processor in accordance with the second embodiment of the present invention, showing how coordinate calculations are executed in the (4×1) mode when the repetition count is i;

FIG. 29 is a conceptual diagram of (4×4) filtering;

FIG. 30 is a conceptual diagram of (4×4) filtering based on the method for image processing in accordance with the second embodiment of the present invention;

FIG. 31 is a photograph of a texture image not subjected to a filtering process yet, showing how (4×4) filtering is executed by the method for image processing in accordance with the second embodiment of the present invention;

FIG. 32 is a block diagram of a texture unit provided in a graphic processor in accordance with a third embodiment of the present invention;

FIG. 33 is a block diagram of a filtering coefficient holding unit provided in the graphic processor in accordance with the third embodiment of the present invention;

FIG. 34 is a block diagram of a filtering coefficient acquisition unit provided in the graphic processor in accordance with the third embodiment of the present invention;

FIG. 35 is a block diagram of a filtering processing unit provided in the graphic processor in accordance with the third embodiment of the present invention;

FIG. 36 is a flowchart of a method for image processing in accordance with the third embodiment of the present invention;

FIG. 37 is a block diagram of the filtering coefficient acquisition unit provided in the graphic processor in accordance with the third embodiment of the present invention, wherein a coefficient entry 0 is selected;

FIG. 38 is a block diagram of the filtering coefficient acquisition unit provided in the graphic processor in accordance with the third embodiment of the present invention, wherein a coefficient entry 1 is selected;

FIG. 39 is a block diagram of the filtering coefficient acquisition unit provided in the graphic processor in accordance with the third embodiment of the present invention, wherein a coefficient entry j is selected;

FIG. 40 is a flowchart of the method for image processing in accordance with the third embodiment of the present invention, particularly showing a filtering process;

FIG. 41 is a block diagram of a texture unit provided in a graphic processor in accordance with a fourth embodiment of the present invention;

FIG. 42 is a block diagram of a filtering coefficient holding unit provided in the graphic processor in accordance with the fourth embodiment of the present invention;

FIG. 43 is a block diagram of an interpolation coefficient table provided in the graphic processor in accordance with the fourth embodiment of the present invention;

FIG. 44 is a flowchart of a method for image processing in accordance with the fourth embodiment of the present invention;

FIG. 45 is a block diagram of a filtering coefficient acquisition unit provided in the graphic processor in accordance with the fourth embodiment of the present invention, wherein a coefficient entry 0 and an in-table entry 0 are selected;

FIG. 46 is a block diagram of the filtering coefficient acquisition unit provided in the graphic processor in accordance with the fourth embodiment of the present invention, wherein the coefficient entry 0 and an in-table entry 1 are selected;

FIG. 47 is a block diagram of the filtering coefficient acquisition unit provided in the graphic processor in accordance with the fourth embodiment of the present invention, wherein a coefficient entry j and an in-table entry i are selected;

FIG. 48 is a schematic diagram showing that a polygon is irradiated with light from a light source;

FIG. 49 is a conceptual diagram showing how to calculate the inner products of parameters for a vertex of the polygon and lighting coefficients;

FIG. 50 is a conceptual diagram showing how to calculate the inner products of parameters for the vertex of the polygon and the lighting coefficients on the basis of a method for image processing in accordance with a fifth embodiment of the present invention;

FIG. 51 is a conceptual diagram of the parameters for the vertex of the polygon for the method for image processing in accordance with the fifth embodiment of the present invention;

FIG. 52 is a conceptual diagram of lighting coefficients for the method for image processing in accordance with the fifth embodiment of the present invention;

FIG. 53 is a conceptual diagram showing how to calculate the inner products of the parameters for the vertex of the polygon and the lighting coefficients on the basis of the method for image processing in accordance with the fifth embodiment of the present invention;

FIG. 54 is a schematic diagram of an MPEG image used for a graphic processor in accordance with a sixth embodiment of the present invention;

FIG. 55 is a flowchart of a method for image processing in accordance with a sixth embodiment of the present invention;

FIG. 56 is a conceptual diagram of (4×1) filtering based on the method for image processing in accordance with the sixth embodiment of the present invention;

FIG. 57 is a conceptual diagram of (1×4) filtering based on the method for image processing in accordance with the sixth embodiment of the present invention;

FIG. 58 is a flowchart of a method for image processing in accordance with a seventh embodiment of the present invention;

FIG. 59 is a conceptual diagram showing the relationship between a plurality of images used for the method for image processing in accordance with the seventh embodiment of the present invention and their definitions;

FIG. 60 is a block diagram of a pixel processing unit that executes the method for image processing in accordance with the seventh embodiment of the present invention;

FIG. 61 is a conceptual diagram showing a plurality of images used for the method for image processing in accordance with the seventh embodiment of the present invention and how the images are linearly interpolated;

FIG. 62 is a flowchart of a method for image processing in accordance with an eighth embodiment of the present invention;

FIG. 63 is a schematic diagram of an image to which the method for image processing in accordance with the eighth embodiment of the present invention is applied;

FIG. 64 is a schematic diagram of an image to which the method for image processing in accordance with the eighth embodiment of the present invention is applied, showing how a shadow portion is filtered;

FIG. 65 is a schematic diagram of an image resulting from the application of the method for image processing in accordance with the eighth embodiment of the present invention;

FIG. 66 is a schematic diagram of texels read by a graphic processor in accordance with a ninth embodiment of the present invention, showing the positional relationship among the texels read when a parameter E is varied in the (4×1) mode;

FIG. 67 is a schematic diagram of texels read by the graphic processor in accordance with the ninth embodiment of the present invention, showing the positional relationship among the texels read when the parameter E is varied in the (1×4) mode;

FIG. 68 is a schematic diagram of texels read by the graphic processor in accordance with the ninth embodiment of the present invention, showing the positional relationship among the texels read when the parameter E is varied in the cross mode;

FIG. 69 is a schematic diagram of texels read by the graphic processor in accordance with the ninth embodiment of the present invention, showing the positional relationship among the texels read when the parameter E is varied in the RC mode;

FIG. 70 is a conceptual diagram of UV coordinates, showing the positions of texels acquired in the (1×4) more of a graphic processor in accordance with a first variation of any of the first to ninth embodiments of the present invention;

FIG. 71 is a conceptual diagram of UV coordinates, showing an offset table provided in a graphic processor in accordance with a second variation of any of the first to ninth embodiments of the present invention;

FIG. 72 is a conceptual diagram of UV coordinates, showing how a graphic processor in accordance with a third variation of any of the first to ninth embodiments of the present invention executes filtering in the (1×4) mode;

FIG. 73 is a block diagram of a filtering process unit provided in a graphic processor in accordance with a fourth variation of any of the first to ninth embodiments of the present invention;

FIG. 74 is a flowchart of a method for image processing in accordance with a fifth variation of any of the first to ninth embodiments of the present invention;

FIG. 75 is a flowchart of a method for image processing in accordance with a sixth variation of any of the first to ninth embodiments of the present invention;

FIG. 76 is a block diagram of a digital television including the graphic processor in accordance with any of the first to ninth embodiments of the present invention; and

FIG. 77 is a block diagram of a recording/reproducing apparatus comprising the graphic processor in accordance with any of the first to ninth embodiments of the present invention.

### DETAILED DESCRIPTION OF THE INVENTION

### First Embodiment

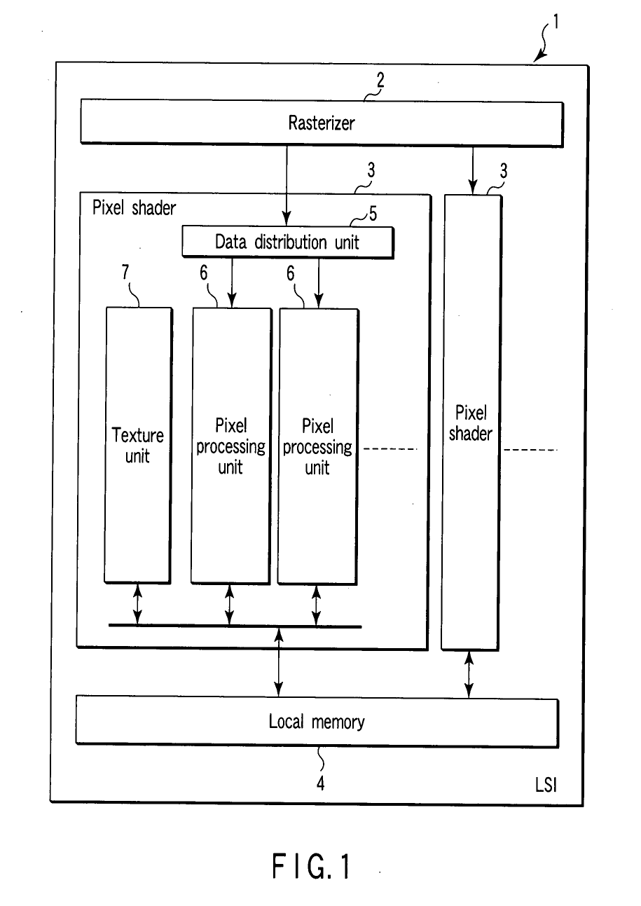

With reference to FIG. 1, description will be given of a method and device for image processing in accordance with a first embodiment of the present invention. FIG. 1 is a block diagram of a graphic processor in accordance with the present embodiment.

As shown in the figure, a graphic processor 1 includes a rasterizer 2, a plurality of pixel shaders 3, and a local memory 4. The number of pixel shaders 3 may be, for example, 4, 8, 16, or 32 and is not limited.

The rasterizer 2 generates pixels in accordance with input graphic information. The pixel is a minimum unit area handled to draw a predetermined graphic. A graphic is drawn using a set of pixels. Pixels generated are introduced into the pixel shader 3.

The pixel shader 3 executes an arithmetic process on the pixels provided by the rasterizer 2 to generate an image on the local memory 4. Each of the pixel shaders 3 includes a data distribution unit 5, a plurality of pixel processing units 6, and a texture unit 7. The data distribution unit 5 receives pixels from the rasterizer 2. The data distribution unit 5 distributes the received pixels to the pixel processing units 6. Each of the pixel processing units 6 is a shader engine unit and executes a shader program on the pixel. The pixel processing units 6 perform respective single-instruction multiple-data (SIMD) operations to process the plurality of pixels. The texture unit 7 reads a texture from the local memory 4 and executes a process required for texture mapping. Texture mapping is a process for applying a texture to the pixels processed by the pixel processing unit 6 and is executed by the pixel processing unit 6.

The local memory 4 is, for example, an embedded DRAM (eDRAM) and stores pixels drawn by the pixel shader 3. The local memory 4 also stores textures.

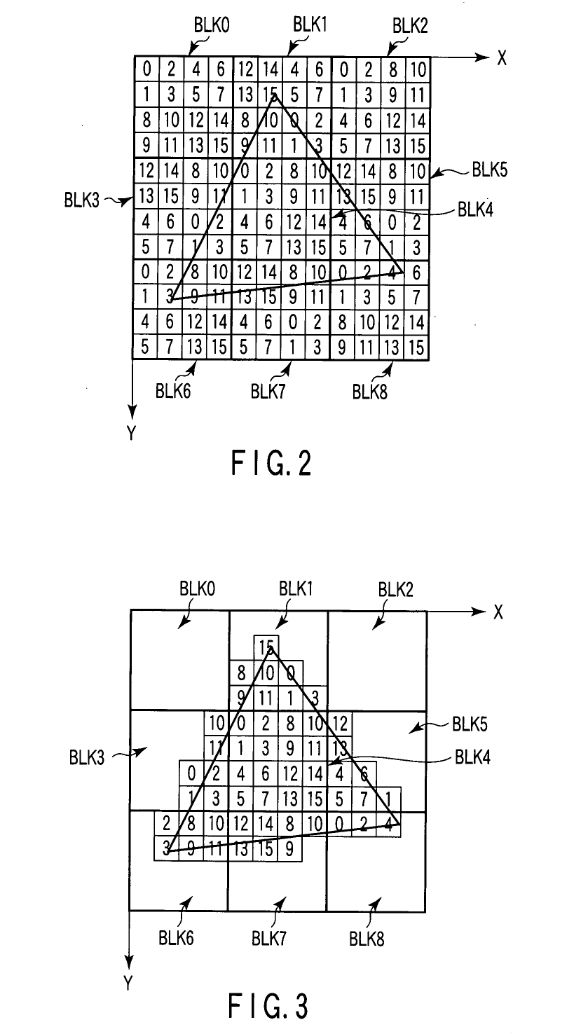

Now, description will be given of the concept of graphic drawing executed by the graphic processor 1 in accordance with the present embodiment. FIG. 2 is a conceptual diagram showing a part of a two-dimensional space (XY coordinate space) in which a graphic is to be drawn. The drawing area shown in FIG. 2 corresponds to a memory space (hereinafter referred to as a frame buffer) in the local memory 4 in which pixels are held.

As shown in the figure, the frame buffer includes a plurality of blocks BLK0 to BLKn (n is a natural number) arranged in a matrix. FIG. 2 shows only (3×3) blocks BLK0 to BLK8, but the number of blocks is not particularly limited. The pixel shader 3 generates pixels in units of the block. Each block includes, for example, (4×4) pixels arranged in a matrix. The number of pixels included in one block is not particularly limited to 16. In actuality, more pixels are usually included in one block. For simplification, a case with 16 pixels will be described. In FIG. 2, the number assigned to each pixel is called a pixel ID. The pixels are thus hereinafter referred to as pixels 0 to 15.

Now, description will be given of a graphic to be drawn in the frame buffer. First, to draw a graphic, graphic information is input to the rasterizer. The graphic information is, for example, information on the vertices or colors of the graphic. Here, drawing of a triangle will be described by way of example. A triangle input to the rasterizer 2 takes such a position in the drawing space as shown in FIG. 2. That is, it is assumed that the three vertex coordinates are located in the pixel 15 in the block BLK1, the pixel 3 in the block BLK6, and the pixel 4 in the block BLK8. The rasterizer 2 generates pixels corresponding to the positions taken by the triangle to be drawn. This is shown in FIG. 3. The pixels generated are sent to the pre-associated pixel shaders 3 The pixel shaders 3 execute a drawing process on the respective pixels. As a result, such a triangle as shown in FIG. 3 is shown using a plurality of pixels. The pixels drawn by the pixel shaders 3 are stored in the local memory 4.

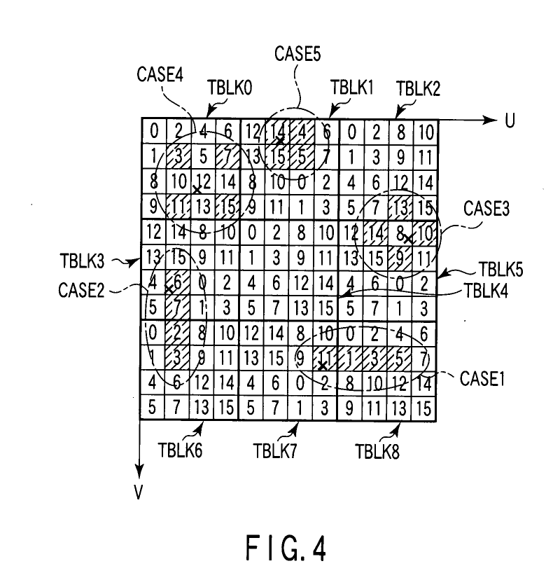

Now, textures will be described with reference to FIG. 4. FIG. 4 is a conceptual diagram showing a part of a texture. The texture is a two-dimensional image to be applied to drawn pixels. Applying a texture to pixels enables various patterns to the surface of an object. A texture includes a plurality of texture blocks TBLK0 to TBLKm (m is a natural number). FIG. 4 shows only (3×3) texture blocks TBLK0 to TBLK8, but the number of texture blocks is not particularly limited. Each of the texture blocks includes, for example, (4×4) texels arranged in a matrix. Texels are minimum unit components of a texture. The number of texels included in one texture block is not particularly limited to 16. In actuality, more texels are usually included in one block. For simplification, a case with 16 texels will be described. In FIG. 4, the number added to each texel is called a texel ID. The texels are thus hereinafter referred to as texels 0 to 15.

Now, the texture unit 7 in FIG. 1 will be described in detail. The texture unit 7 has an internal cache memory to temporarily hold texels read from the local memory 4. In response to a request from the pixel processing units 6, the texture unit 7 reads texels from the cache memory, executes a filtering process on the texels as required, and then supplies the texels to the pixel processing units 6.

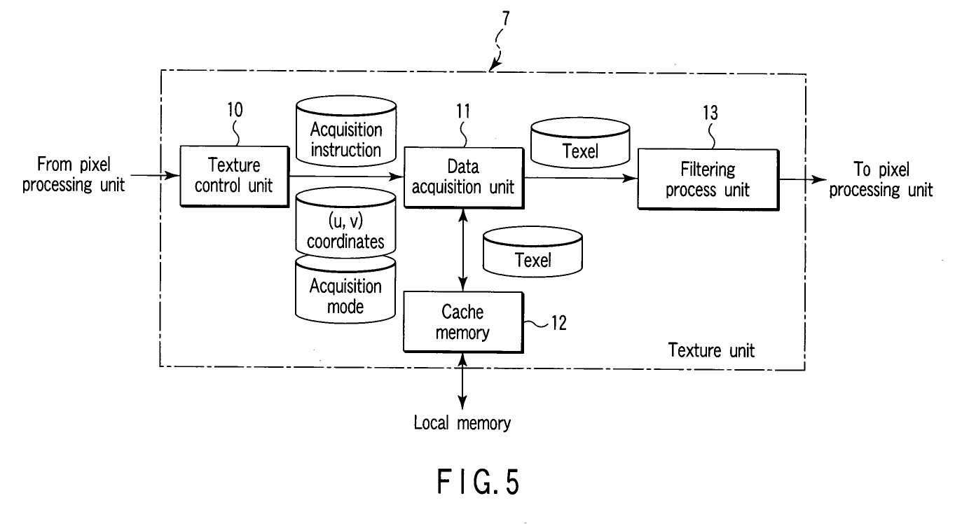

FIG. 5 is a block diagram of the texture unit 7. As shown in the figure, the texture unit 7 includes a texture control unit 10, a data acquisition unit 11, the cache memory 12, and a filtering process unit 13.

The texture control unit 10 controls the data acquisition unit 11 in response to texture requests from the pixel processing units 6. Texture requests are instructions given by the pixel processing units 6 to request texels to be read. In this case, the pixel processing units 6 provides the texture control unit 10 with pixel coordinates (x, y) and a texture acquisition mode. The acquisition mode will be described below. The texture control unit 10 calculates the coordinates (texel coordinates [u, v]) of texels corresponding to input pixel coordinates, outputs the texel coordinates and the acquisition mode to the data acquisition unit 11, and instructs the data acquisition unit 11 to acquire texels.

The data acquisition unit 11 reads four texels from the cache memory 12 on the basis of the input texel information. More specifically, the data acquisition unit 11 calculates the addresses, in the cache memory 12, of the four texels corresponding to the input texel coordinates. Then, on the basis of the calculated addresses, the data acquisition unit 11 reads the four texels from the cache memory 12.

Now, the acquisition mode will be described with reference to FIG. 4. The acquisition mode is information indicating which four texels are to be read in connection with the input pixel coordinates (texel coordinates). FIG. 4 shows five types of acquisition mode (CASES 1 to 5). Crosses in the figure indicate the texel coordinates corresponding to the input pixel coordinates. First, CASE 1 will be described. The CASE 1 acquisition mode acquires a first texel located at the texel coordinates corresponding to the pixel coordinates and three texels having the same V coordinate as that of the first texel and a U coordinate different from that of the adjacent pixel by one. That is, as shown in FIG. 4, (4×1) texels 11, 1, 3, and 5 are read which are arranged horizontally in a line adjacent to one another.

The CASE 2 acquisition mode acquires a first texel located at the texel coordinates corresponding to the pixel coordinates and three texels having the same U coordinate as that of the first texel and a V coordinate different from that of the adjacent pixel by one. That is, as shown in FIG. 4, (1×4) texels 6, 7, 2, and 3 are read which are arranged vertically in a line adjacent to one another.

The CASE 3 acquisition mode acquires four texels arranged in a plus sign form around a texel located at the texel coordinates corresponding to the pixel coordinates. That is, as shown in FIG. 4, four pixels 13, 14, 10, and 9 are read which are arranged in a plus sign form in proximity to texel 8.

The CASE 4 acquisition mode acquires four texels arranged like the letter X around a texel located at the texel coordinates corresponding to the pixel coordinates. That is, as shown in FIG. 4, four pixels 3, 11, 7, and 15 are read which are arranged like the letter X in proximity to texel 12.

The CASE 5 acquisition mode acquires a first texel located at the texel coordinates corresponding to the pixel coordinates, a texel having the same V coordinate as that of the first pixel and a U coordinate different from that of the first pixel by one, a texel having the same U coordinate as that of the first pixel and a V coordinate different from that of the first pixel by one, and a texel having a U coordinate and a V coordinate both different from those of the first pixel by one. That is, as shown in FIG. 4, (2×2) adjacent texels 14, 15, 4, and 5 are read.

CASES 1 to 5 are hereinafter referred to as a (4×1) mode, a (1×4) mode, a cross mode, a rotated cross (RC) mode, and a (2×2) mode, respectively.

The filtering process unit 13 executes a filtering process on the four texels read by the data acquisition unit 11. The filtering process will be described below in detail.

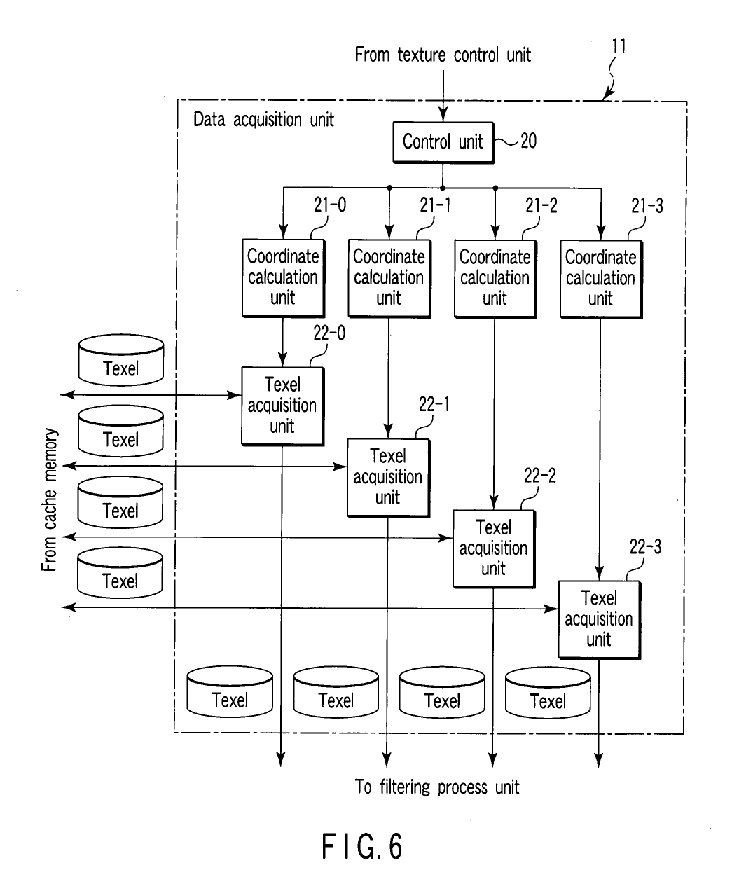

Now, with reference to FIG. 6, description will be given of the configuration of the data acquisition unit 11, provided in the texture unit 7. FIG. 6 is a block diagram of the data acquisition unit 11. As shown in the figure, the data acquisition unit 11 includes a control unit 20, four coordinate calculation units 21-0 to 21-3, and four texel acquisition units 22-0 to 22-3.

The control unit 20 receives a texel acquisition instruction, the texel coordinates corresponding to the pixel coordinates, and the acquisition mode from the texture control unit 10. The control unit 20 then instructs the coordinate calculation units 21-0 to 21-3 to calculate the coordinates of the four texels to be read from the cache memory 12 in accordance with the input texel coordinates and acquisition mode.

The coordinate calculation units 21-0 to 21-3 correspond to the respective texels to be read. The coordinate calculation units 21-0 to 21-3 calculate the texel coordinates of the texels associated with them.

The texel acquisition units 22-0 to 22-3 are associated with the coordinate calculation units 21-0 to 21-3. The texel acquisition units 22-0 to 22-3 calculate the addresses of the texels in the cache memory 12 on the basis of the texel coordinates calculated by the coordinate calculation units 21-0 to 21-3. The texel acquisition units 22-0 to 22-3 read the texels from the cache memory 12. The read texels are provided to the filtering process unit 13.

In FIG. 6 and the above description, the four coordinate calculation units and the four texel acquisition units are provided. However, FIG. 6 only shows the functions of the data acquisition unit 11. The configuration in FIG. 6 may of course be used, but it is also possible to provide only one coordinate calculation unit and only one texel acquisition unit. That is, any configuration may be used provided that it allows four texels to be read.

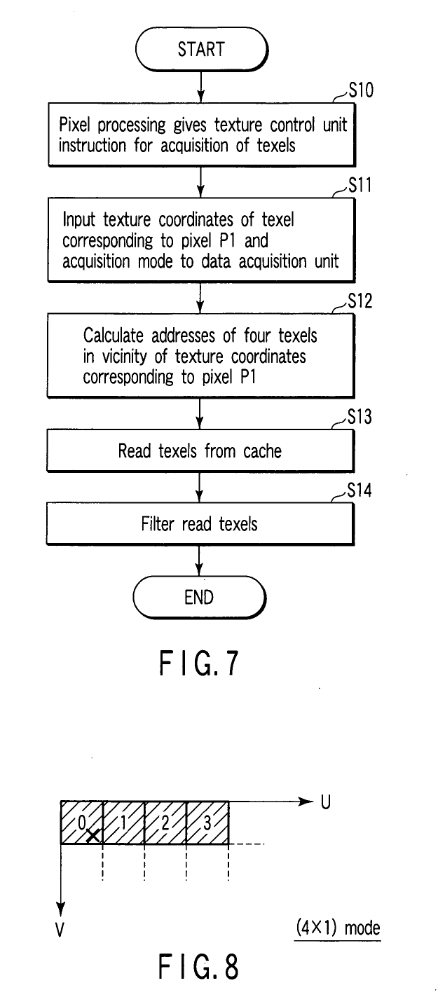

Now, with reference to the flowchart in FIG. 7, description will be given of the operation of the texture unit 7 in the graphic processor 1 configured as described above.

First, the pixel processing unit 6 inputs the XY coordinates of a pixel P1 to the texture control unit 10 and gives the texture control unit 10 an instruction for acquisition of four texels (step S10). At this time, the pixel processing unit 6 also inputs the acquisition mode to the texture control unit 10. Then, the texture control unit 10 calculates the texel coordinates corresponding to the pixel P1. The texture control unit 10 then provides the calculated texel coordinates and the acquisition mode to the data acquisition unit 11, while instructing the data acquisition unit 11 to acquire texels (step S11). The data acquisition unit 11 selects four texels in the vicinity of the texel coordinates corresponding to the pixel P1 in accordance with the acquisition mode and calculates their addresses (step S12). The data acquisition unit 11 further reads texels from the cache memory 12 on the basis of the addresses calculated in step S12 (step S13). The filtering process unit 13 executes a filtering process on the four texels read by the data acquisition unit 11 (step S14). The results of the filtering process are provided to the pixel processing unit 6. The pixel processing unit 6 applies the texels resulting from step S14 (filtered texels) to the pixel P1 (texture mapping).

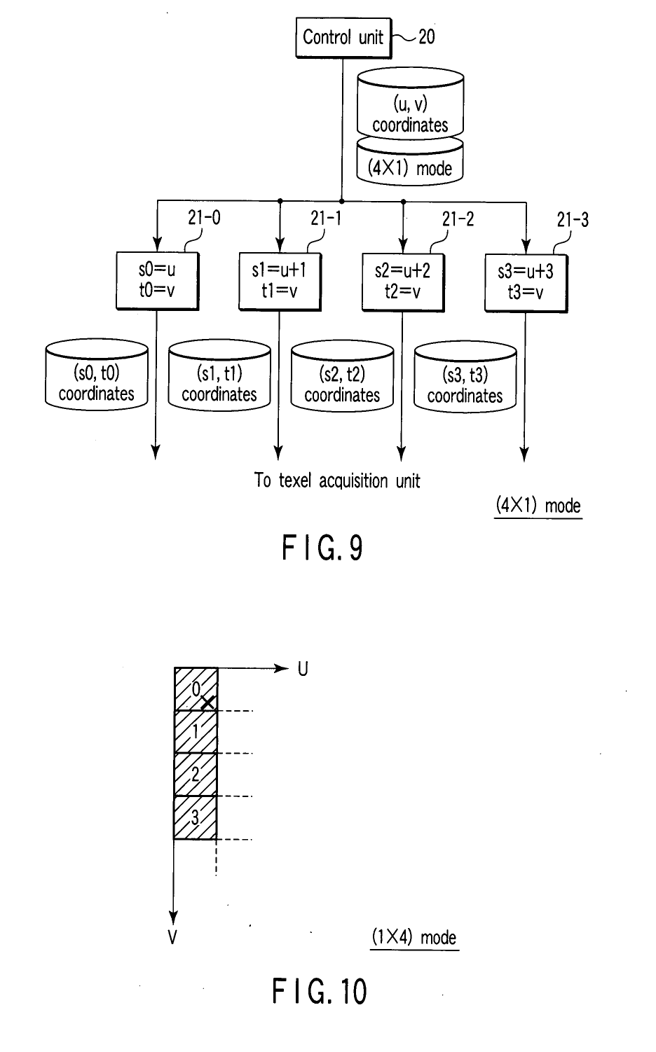

A specific example of the above step S12 will be described with reference to FIGS. 8 to 17. FIGS. 8, 10, 12, 14, and 16 show UV coordinates indicating the positions of texels read in the (4×1) mode, (1×4) mode, cross mode, RC mode, and (2×2) mode, that is, the texel coordinates corresponding to the pixel coordinates of the crossed pixel in the figures. FIGS. 9, 11, 13, 15, and 17 are block diagrams showing a part of the configuration of the data acquisition unit 11 in the (4×1) mode, (1×4) mode, cross mode, RC mode, and (2×2) mode. For simplification, the read four pixels are hereinafter referred to as texels 0 to 3.

First, the (4×1) mode will be described with reference to FIGS. 8 and 9. As shown in FIG. 8, it is assumed that in the (4×1) mode, texel 0 corresponds to the pixel coordinates. Then, texels are read which have the same V coordinate as that of texel 0 and a U coordinate incrementing by 1 starting with that of texel 0. Accordingly, when the coordinates of texels 0 to 3 are defined as (s0, t0), (s1, t1), (s2, t2), and (s3, t3), the coordinate calculation unit 21-0 calculates s0=u and t0=v for texel 0. The coordinate calculation unit 21-1 calculates s1=u +1 and t1=v for texel 1. The coordinate calculation unit 21-2 calculates s2=u +2 and t2=v for texel 2. The coordinate calculation unit 21-3 calculates s3=u+3 and t3=v for texel 3. These coordinates (s0, t0), (s1, t1), (s2, t2), and (s3, t3) are provided to the texel acquisition units 22-0 to 22-3, which calculates the addresses corresponding to the provided coordinates.

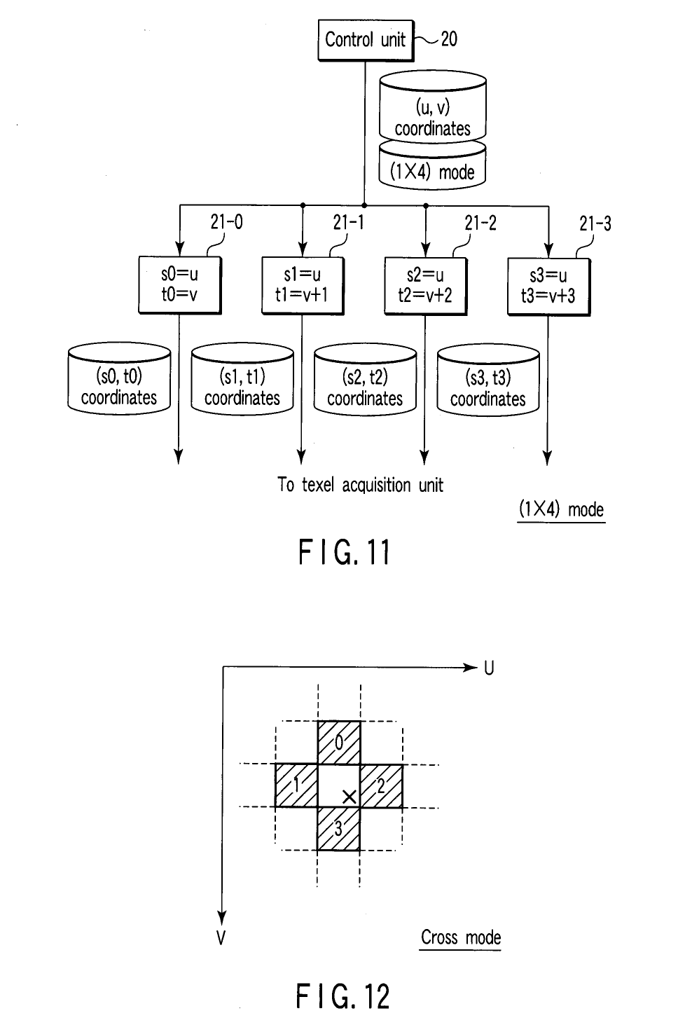

Now, the (1×4) mode will be described with reference to FIGS. 10 and 11. As shown in FIG. 10, it is assumed that in the (1×4) mode, texel 0 corresponds to the pixel coordinates. Then, texels 1 to 3 are read which have the same U coordinate as that of texel 0 and a V coordinate incrementing by 1 starting with that of texel 0. Accordingly, the coordinate calculation unit 21-0 calculates s0=u and t0=v for texel 0. The coordinate calculation unit 21-1 calculates s1=u and t1=v+1 for texel 1. The coordinate calculation unit 21-2 calculates s2=u and t2=v+2 for texel 2. The coordinate calculation unit 21-3 calculates s3=u and t3=v+3 for texel 3. These coordinates (s0, t0), (s1, t1), (s2, t2), and (s3, t3) are provided to the texel acquisition units 22-0 to 22-3, which calculates the addresses corresponding to the provided coordinates.

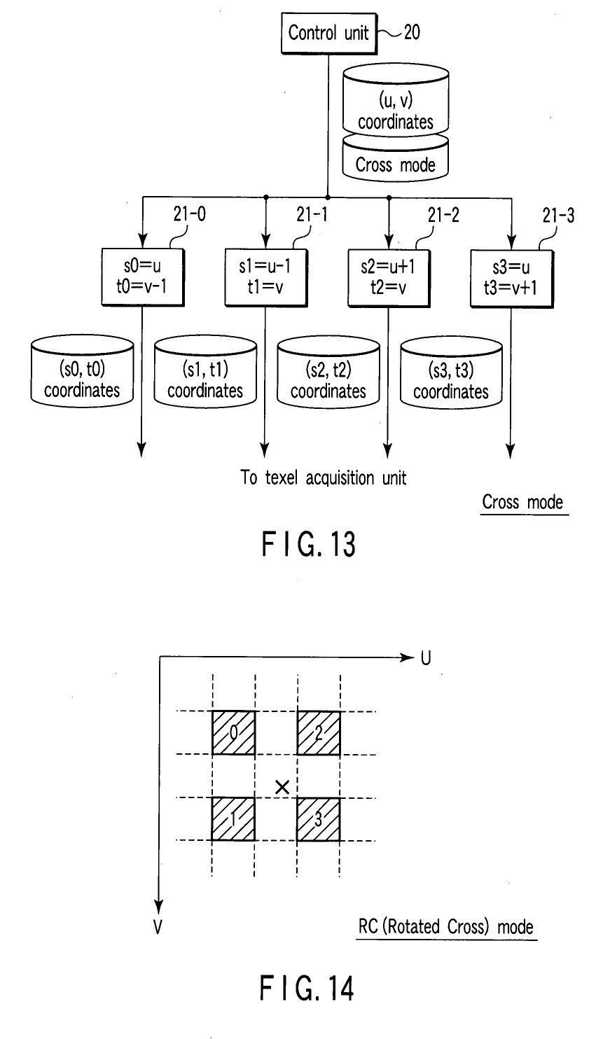

Now, the cross mode will be described with reference to FIGS. 12 and 13. As shown in FIG. 12, the cross mode reads texels 0 and 3 having the same U coordinate as that of the pixel and a V coordinate different from that of the pixel by −1 and +1, respectively, and texels 1 and 2 having the same V coordinate as that of the pixel and a U coordinate different from that of the pixel by −1 and +1, respectively. Consequently, the coordinate calculation unit 21-0 calculates s0=u and t0=v−1 for texel 0. The coordinate calculation unit 21-1 calculates s1=u−1 and t1=v for texel 1. The coordinate calculation unit 21-2 calculates s2=u+1 and t2=v for texel 2. The coordinate calculation unit 21-3 calculates s3=u and t3=v+1 for texel 3. These coordinates (s0, t0), (s1, t1), (s2, t2), and (s3, t3) are provided to the texel acquisition units 22-0 to 22-3, which calculates the addresses corresponding to the provided coordinates.

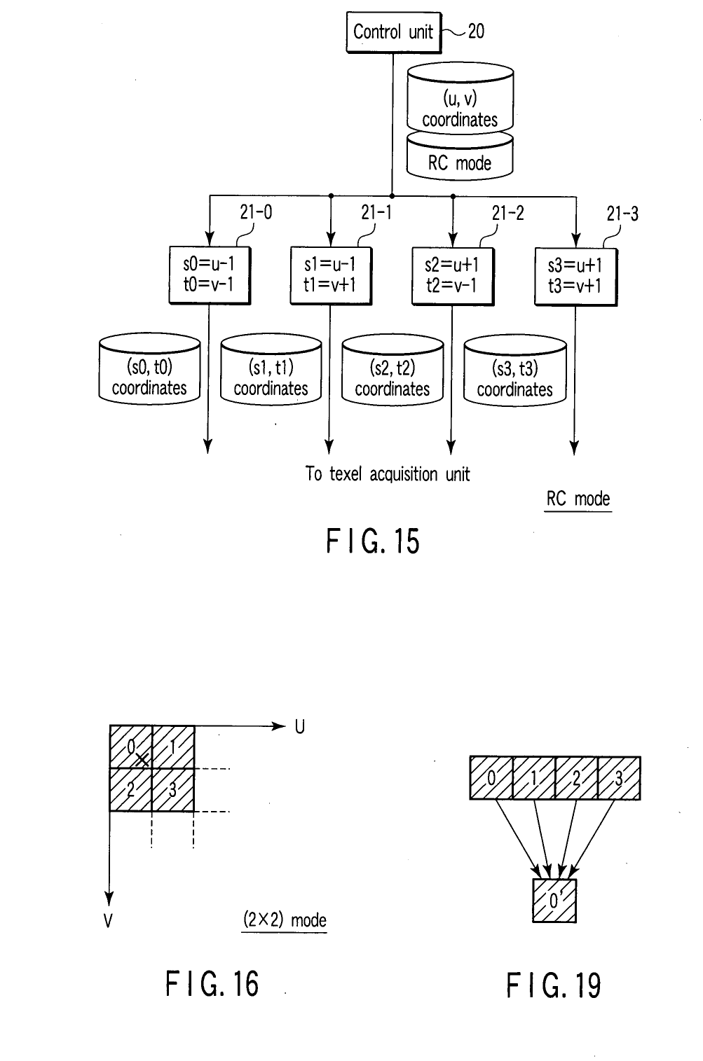

Now, the RC mode will be described with reference to FIGS. 14 and 15. As shown in FIG. 14, the RC mode reads texels 0 and 1 having a U coordinate different from that of the pixel by −1 and a V coordinate different from that of the pixel by −1 and +1, respectively, and texels 2 and 3 having a U coordinate different from that of the pixel by +1 and a V coordinate different from that of the pixel by −1 and +1, respectively. Consequently, the coordinate calculation unit 21-0 calculates s0=u−1 and t0=v−1 for texel 0. The coordinate calculation unit 21-1 calculates s1=u−1 and t1=v+1 for texel 1. The coordinate calculation unit 21-2 calculates s2=u+1 and t2=v−1 for texel 2. The coordinate calculation unit 21-3 calculates s3=u+1 and t3=v+1 or texel 3. These coordinates (s0, t0), (s1, t1), (s2, t2), and (s3, t3) are provided to the texel acquisition units 22-0 to 22-3, which calculates the addresses corresponding to the provided coordinates.

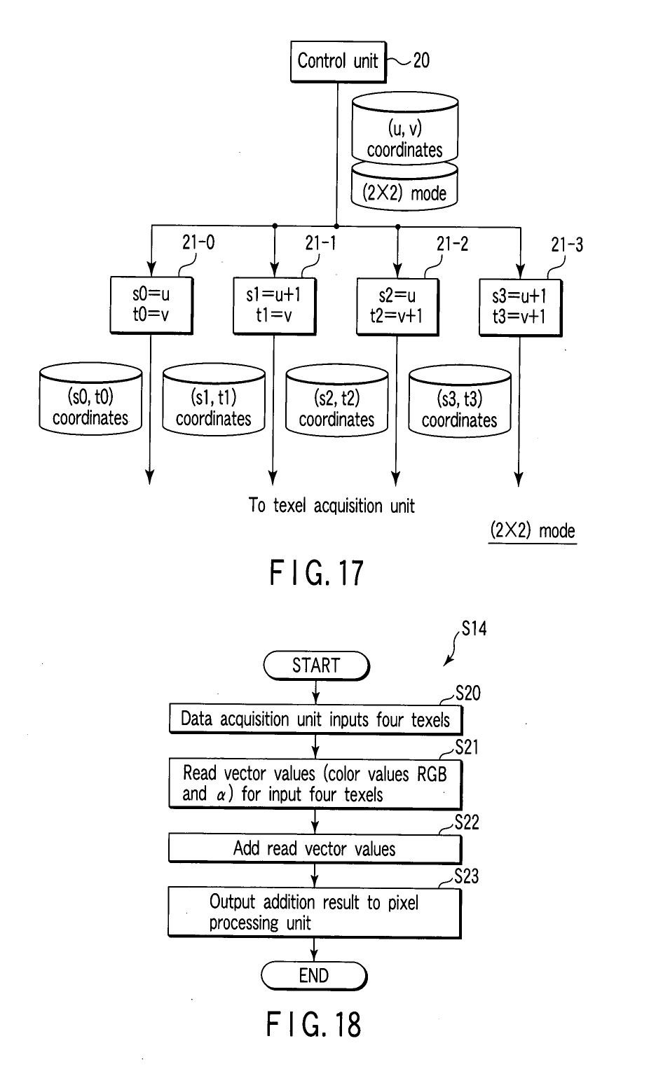

Now, the (2×2) mode will be described with reference to FIGS. 16 and 17. As shown in FIG. 16, it is assumed that in the (2×2) mode, texel 0 corresponds to the pixel coordinates. Then, in addition to texel 0, the following texels are read: texel 1 having the same V coordinate as that of texel 0 and a U coordinate different from that of texel 0 by 1, texel 2 having the same U coordinate as that of texel 0 and a V coordinate different from that of texel 0 by 1, and texel 3 having a U coordinate and a V coordinate different from those of texel 0 by 1. Consequently, the coordinate calculation unit 21-0 calculates s0=u and t0=v for texel 0. The coordinate calculation unit 21-1 calculates s1=u+1 and t1=v for texel 1. The coordinate calculation unit 21-2 calculates s2=u and t2=v+1 for texel 2. The coordinate calculation unit 21-3 calculates s3=u+1 and t3=v+1 for texel 3. These coordinates (s0, t0), (s1, t1), (s2, t2), and (s3, t3) are provided to the texel acquisition units 22-0 to 22-3, which calculates the addresses corresponding to the provided coordinates.

Now, with reference to FIG. 18, description will be given of a filtering process (step S14) executed by the filtering process unit 13. FIG. 18 is a flowchart of a filtering process. First, as described above, four texels read by the data acquisition unit 11 are input to the filtering process unit 13 (step S20). Then, the filtering process unit 13 reads vector values for the input four texels (step S21). The vector values include, for example, color values (RGB) indicating colors and transparency (α). The vector values read for the four texels are added together (step S22). The result of the addition corresponds to a texel resulting from a filtering process. The filtering process unit 13 outputs the addition result to the pixel processing unit 6 (step S23). The filtering process is not limited to the addition of the vector values, for example, the weighted average using weighted vectors value can be used.

FIG. 19 is a conceptual diagram schematically showing how a filtering process is executed. As shown in the figure, when it is assumed that the four texels 0 to 3 are input to the filtering process unit 13, the result of the addition of these vector values corresponds to texel 0′. Thus, texel 0′, reflecting the four texels 0 to 3, is applied to the pixel.

Filtering processes on texels 0 to 3 read in the (4×1) mode, (1×4) mode, cross mode, RC mode, and (2×2)mode are hereinafter sometimes called (4×1) filtering, (1×4) filtering, cross filtering, RC filtering, and (2×2)filtering. All these filtering processes use four texels.

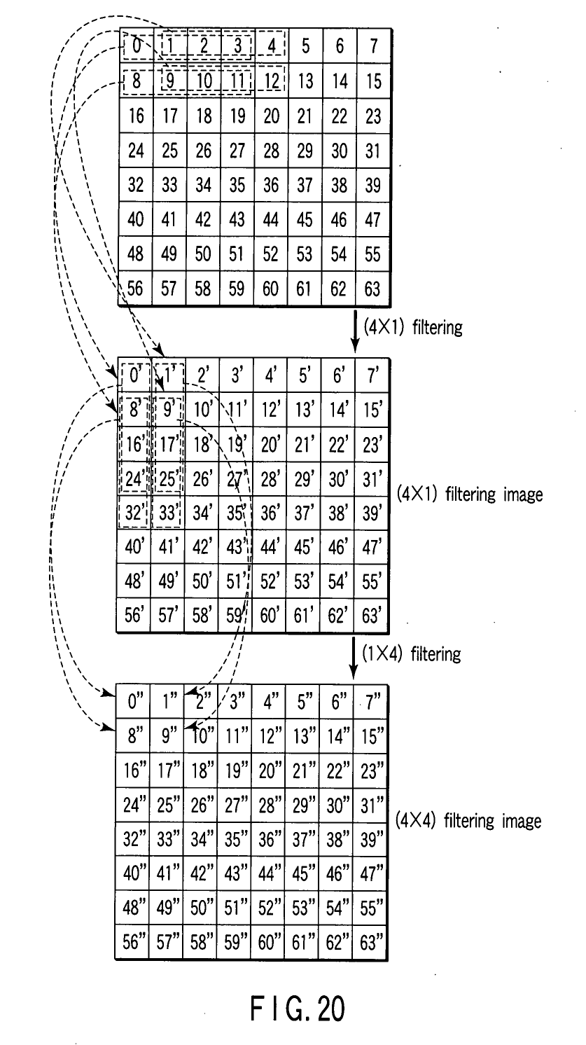

FIG. 20 shows how (4×4) filtering is executed in accordance with the present embodiment. (4×4) filtering is a filtering process executed on one pixel using (4×4)=16 texels. In the description below, a texture image containing (8×8) texels 0 to 63 is subjected to (4×4) filtering.

As shown in the figure, the above technique is used to execute (1×4) filtering on the 64 texels 0 to 63. That is, for example, for texel 0, texels 0 to 3 are read and subjected to (1×4) filtering. For texel 1, texels 1 to 4 are read and subjected to (1×4) filtering. For texel 8, texels 8 to 11 are read and subjected to (1×4) filtering. For texel 9, texels 9 to 12 are read and subjected to (1×4) filtering.

Filtering results obtained by executing (1×4) filtering on the (8×8) texels 0 to 63 as described above are called texels 0′ to 63′. These texels are arranged in an (8×8) form to obtain a new texture image. Then, the above technique is used to execute (4×1) filtering on the texture image containing the resulting 64 texels 0′ to 63′. That is, for example, for texel 0′, texels 0′, 8′, 16′, and 24′ are read and subjected to (1×4) filtering. For texel 1′, texels 1′, 9′, 17′, and 25′are read and subjected to (1×4) filtering. For texel 8′, texels 8′, 16′, 24′, and 32′are read and subjected to (1×4) filtering. For texel 9′, texels 9′, 17′, 25′, and 33′ are read and subjected to (1×4) filtering.

Filtering results obtained by executing (4×1) filtering on the (8×8) texels 0′ to 63′ as described above are called texels 0“to 63”. These texels are arranged in an (8×8) form to obtain a new texture image. The results constitute a texture image with each texel subjected to (4×4) filtering.

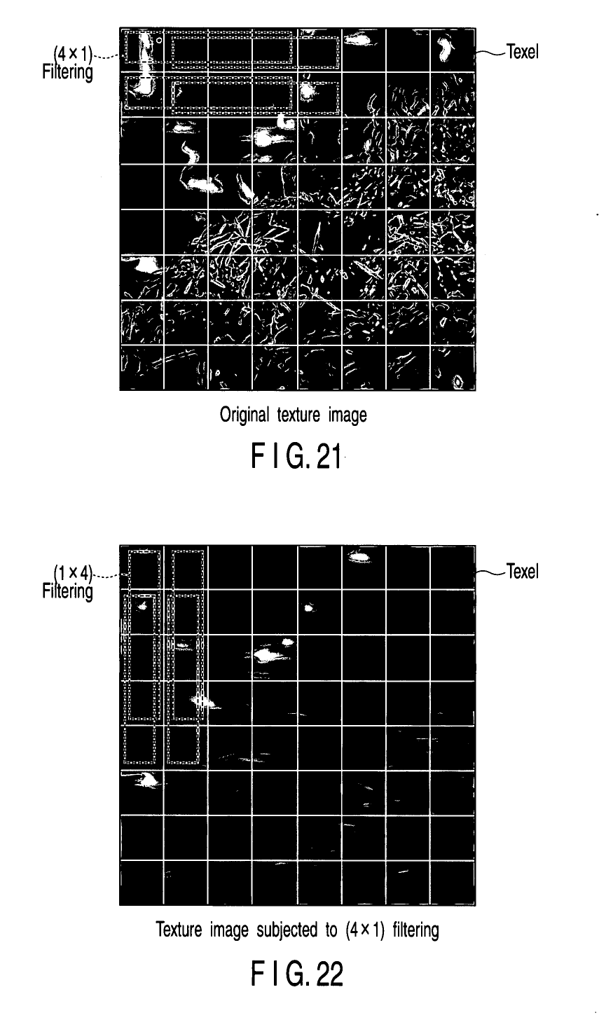

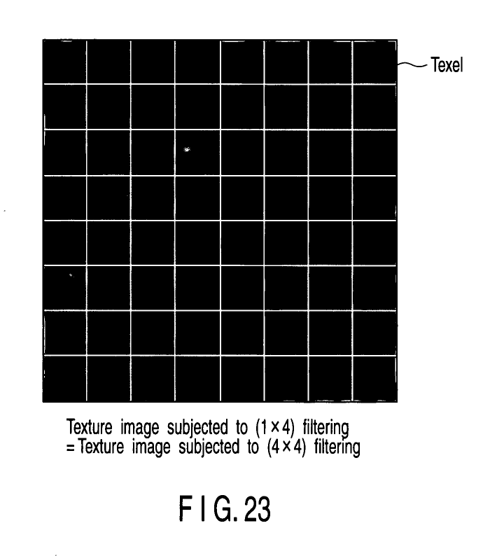

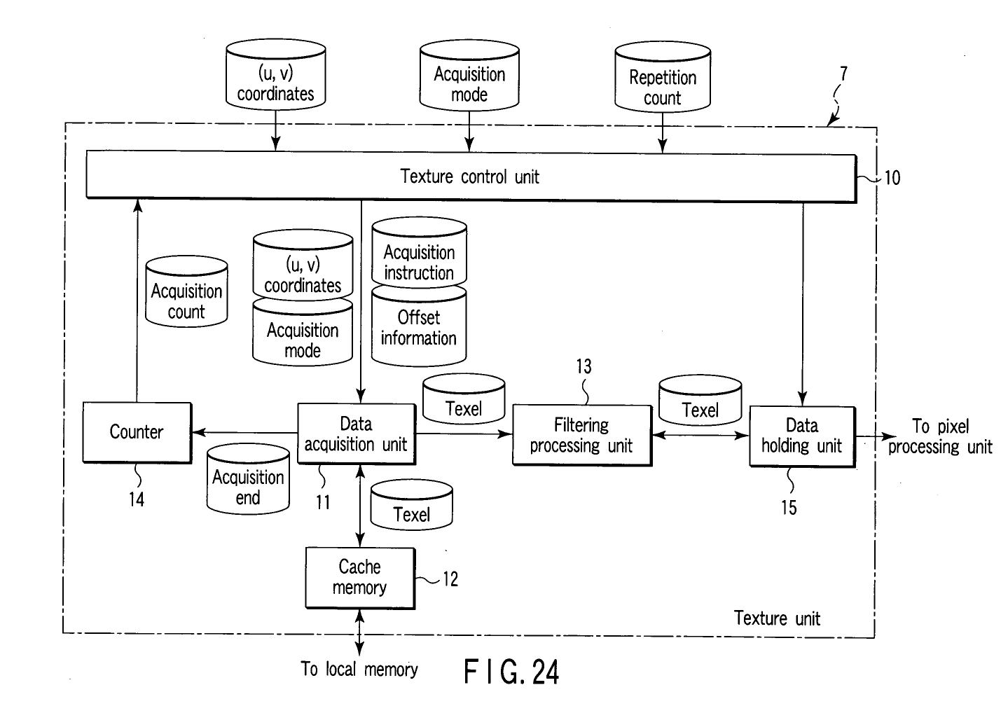

A specific example of FIG. 20 will be described with reference to FIGS. 21 to 23. FIG. 21 shows a texture image not subjected to a filtering process yet. FIG. 22 shows a texture image created by subjecting the image in FIG. 21 to (4×1) filtering. FIG. 23 shows a texture image created by subjecting the image in FIG. 22 to (1×4) filtering. As shown in the figure, (4×1) filtering results in a texture image that is blurred in a horizontal direction. Subsequent (1×4) filtering results in an image that is further blurred in a vertical direction. This results in such a (4×4) filtering result as shown in FIG. 23.

The graphic processor in accordance with the first embodiment of the present invention described above exerts Effect 1.

(1) The degree of freedom of a filtering process can be improved (1).

The graphic processor in accordance with the present embodiment allows the data acquisition unit 11 to read a plurality of texels from the cache memory 12 in any of the various acquisition modes other than the (2×2) mode. Thus, suitable filtering process can be executed by selecting any one of the acquisition mode as required.

For example, the conventional graphic processor for texture mapping allows only (2×2) texels to be acquired. Accordingly, (4×1) filtering with the conventional configuration unavoidably requires such a method as described below. When the UV coordinate point corresponding to the pixel coordinates is called a sampling point, (2×2) texels including the sampling point are read. Further, (2×2) texels adjacent to the above (2×2) texels are read. Then, four texels having V coordinates different from that of the sampling point are discarded. Texels having the same V coordinate as that of the sampling point are used for filtering. That is, the data acquisition unit 11 needs to execute texel acquisition twice.

However, according to the present embodiment, the data acquisition unit 11 calculates texel coordinates in accordance with the acquisition mode. This allows texels to be read in a mode other than the 2×2) mode. For example, for (4×1) filtering, texels can be read in the (4×1) mode, requiring the data acquisition unit 11 to execute texel acquisition only once. The degree of freedom of a filtering process can thus be increased, while inhibiting a possible increase in the load on the texture unit 7.

### Second Embodiment

Now, description will be given of a method and device for image processing in accordance with a second embodiment of the present invention. In the present embodiment, the data acquisition unit 11 in accordance with the first embodiment is configured to execute texel acquisition plural times in response to a single texel acquisition instruction from the pixel processing unit 6. FIG. 24 is a block diagram of the texture unit 7 in accordance with the present embodiment. The configuration except for the texture unit 7 is similar to that of the first embodiment and will thus not be described.

As shown in FIG. 24, the texture unit 7 includes the texture control unit 10, the data acquisition unit 11, the cache memory 12, the filtering process unit 13, a counter 14, and a data holding unit 15.

The texture control unit 10 receives a repetition count from the pixel processing unit 6 as information. In addition to providing the functions described in the first embodiment, the texture control unit 10 repeats the issuance of an instruction requesting the data acquisition unit 11 to acquire texels, a number of times equal to the repetition count. For every issuance, the texture control unit 10 outputs address offset information to the data acquisition unit 11. The address offset information will be described below.

The data acquisition unit 11 reads four texels from the cache memory 12 on the basis of input texel coordinates. More specifically, the data acquisition unit 11 uses address offset information to calculate the addresses, in the cache memory 12, of the four texels corresponding to the input texel coordinates. The data acquisition unit 11 then reads the four texels from the cache memory 12 on the basis of the calculated addresses.

The counter 14 counts the number of times that the data acquisition unit 11 has read a texel.

The cache memory 12 and the filtering process unit 13 are as described in the first embodiment.

The data holding unit 15 holds the results of a filtering process executed by the filtering process unit 13.

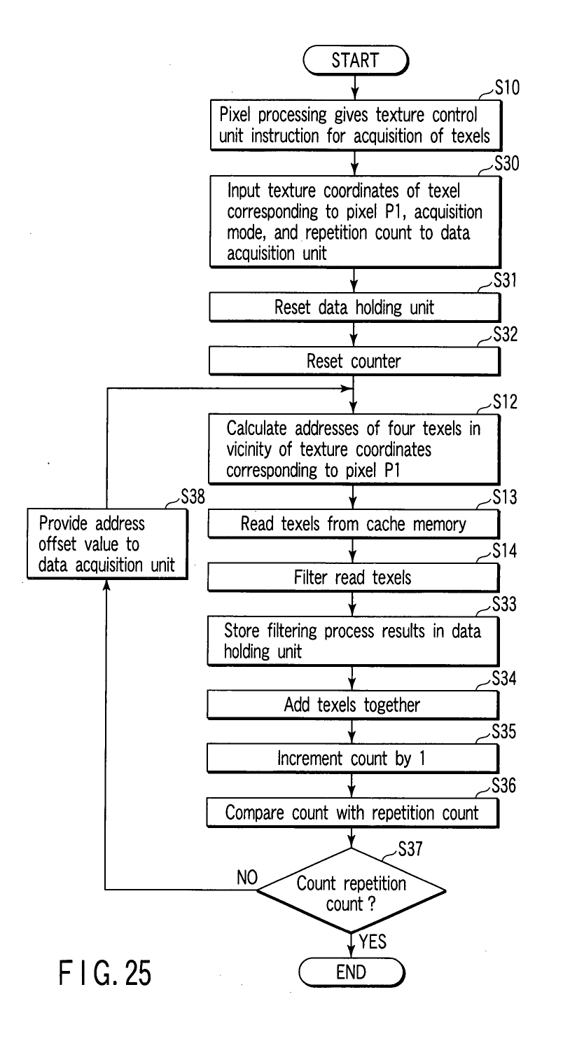

Now, with reference to the flowchart in FIG. 25, description will be given of the operation of the texture unit 7 in the graphic processor 1 configured as described above.

First, the pixel processing unit 6 inputs the XY coordinates of a certain pixel P1 to the texture control unit 10. The pixel processing unit 6 also gives the texture control unit 10 an instruction for acquisition of four texels corresponding to the pixel P1 (step S10). In this case, the pixel processing unit 6 inputs not only the acquisition mode but also the repetition count to the texture control unit 10. Then, the texture control unit 10 calculates the texel coordinates corresponding to the pixel P1. The texture control unit 10 provides the data acquisition unit 11 with the calculated texel coordinates and the acquisition mode, while instructing the data acquisition unit 11 to acquire texels (step S30). In this case, the texture control unit 10 may also provide the repetition count to the data acquisition unit 11. The texture control unit 10 further resets the data in the data holding unit 15 (step S31) and the counter value in the counter 14 (step S32).

Then, the data acquisition unit 11 selects four texels in the vicinity of the texel coordinates (sampling point) corresponding to the pixel P1 in accordance with the acquisition mode and calculates their addresses (step S12). The data acquisition unit 11 further reads texels from the cache memory 12 on the basis of the addresses calculated in step S12 (step S13). The filtering process unit 13 executes a filtering process on the four texels read by the data acquisition unit 11 (step S14). The results of the filtering process are held in the data holding unit 15 (step S33). The data holding unit 15 adds the newly provided data to already held data (step S34). However, immediately after resetting of the data holding unit 31, the input texels are held as they are.

Once the data acquisition unit 11 completes reading texels (step S13), the counter 14 increments the counter value in response to acquisition end information provided by the data acquisition unit 11 (step S35). The texture control unit 10 then checks the counter value and compares it with the repetition count (step S36). Once the counter value has reached the repetition count (step S37, YES), the process ends. If the counter value has not reached the repetition count (step S37, NO), the texture control unit 10 provides the data acquisition unit 11 with an address offset value and instructs the data acquisition unit 11 to acquire texels again (step S38). If the repetition count is provided to the data acquisition unit, the data acquisition unit 11 may execute the processing in steps S36 and S37.

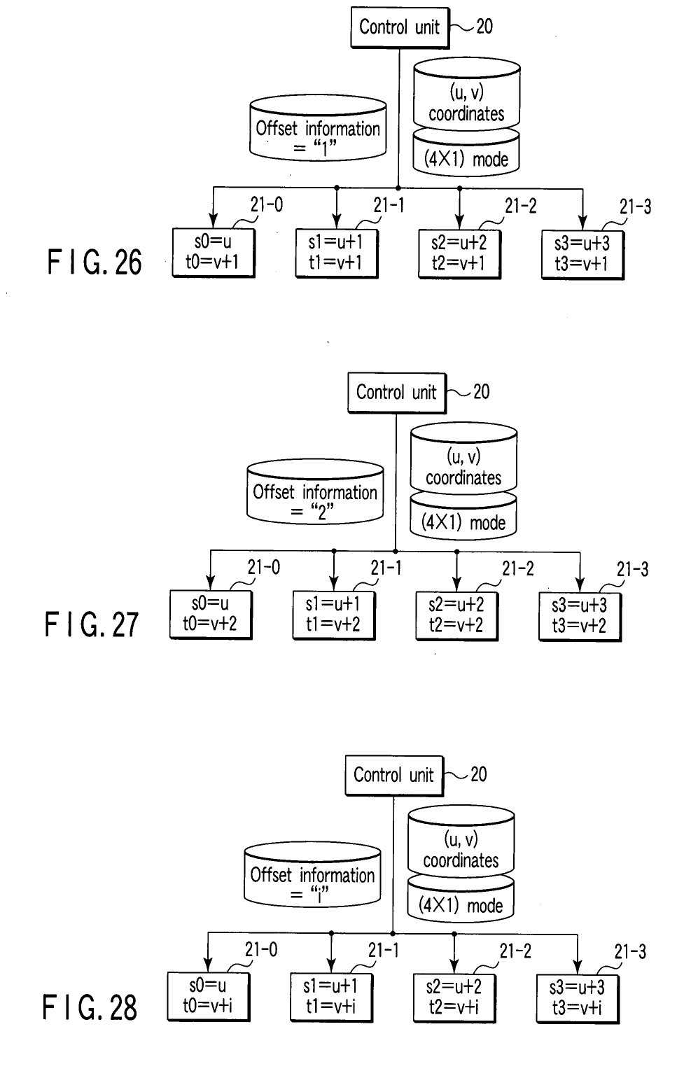

The processing in steps S12 to S14 and S33 to S38 is subsequently repeated until the counter value reaches the repetition count. In this case, the address offset value provided in step S38 is used for the address calculation in step S12. Step S12 will be described with reference to FIGS. 26 to 28. FIGS. 26 to 28 are block diagrams partly showing the configuration of the data acquiring mode in the (4×1) mode. FIG. 26 shows that the counter value is 1, FIG. 27 shows that the counter value is 2, and FIG. 28 shows that the counter value is i (i is a natural number. In the description below, the UV coordinates of the sampling point are (u, v).

First, if the counter value is zero, the coordinate calculation units 21-0 to 21-3 executes the calculation shown in FIG. 9 to calculate four texel coordinate pairs (s0, t0), (s1, t1), (s2, t2), and (s3, t3) as is the case with the first embodiment.

Now, with reference to FIG. 26, description will be given of a case with a counter value of 1. As shown in the figure, the control unit 20 provides an address offset value of 1 to the coordinate calculation units 21-0 to 21-3. Then, the coordinate calculation units 21-0 to 21-3 increment the respective values by 1 in the V axis direction. That is, the coordinate calculation units 21-0 to 21-3 calculate four texel coordinates each having the same U coordinate as that for the counter value of zero and a V coordinate different from that for the counter value of zero by 1.

Now, with reference to FIG. 27, description will be given of a case with a counter value of 2. As shown in the figure, the control unit 20 provides an address offset value of 2 to the coordinate calculation units 21-0 to 21-3. Then, the coordinate calculation units 21-0 to 21-3 increment the respective values by 2 in the V axis direction. That is, the coordinate calculation units 21-0 to 21-3 calculate four texel coordinates each having the same U coordinate as that for the counter value of zero and a V coordinate different from that for the counter value of zero by +2.

Now, with reference to FIG. 28, description will be given of a case with a counter value of i. FIG. 28 generalizes the examples shown in FIGS. 26 and 27. As shown in the figure, upon receiving an address offset value of i, the coordinate calculation units 21-0 to 21-3 increment the respective V coordinates by +i. The address offset value i may be the same as the counter value in the counter 14, or for example, when the counter value is defined as k, i=2 k or I=4 k. The address offset value can thus be appropriately set.

Only the case with the (4×1) mode has been described. For the (1×4) mode, i may be added to the U coordinates.

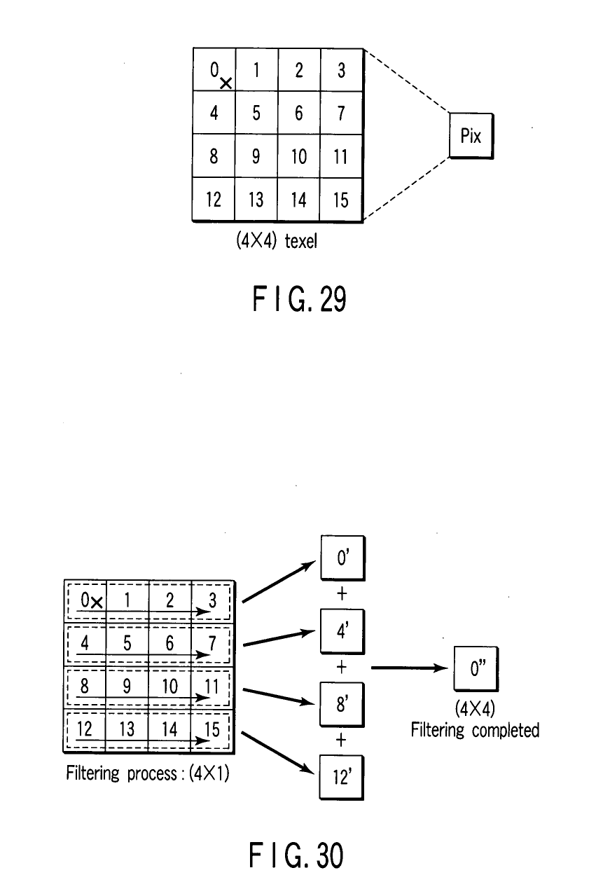

FIGS. 29 and 30 show how (4×4) filtering is executed using (4×1) filtering in accordance with the present embodiment. Description will be given of the case where a filtering process is executed using (4×4)=16 texels 0 to 15 on one pixel as shown in FIG. 29. In this case, the repetition count is 4.

In FIG. 30, the sampling point is crossed. First, the coordinate calculation units 21-0 to 21-3 calculate the coordinates of four texels 0 to 3, texel 0 corresponding to the sampling point, and the set of three adjacent texels 1 to 3 adjacent to texel 0 in the U axis direction (step S12). The texel acquisition units 22-0 to 22-3 then read texels 0 to 3 from the cache memory 12 (step S13). The filtering process unit 13 executes (4×1) filtering on texels 0 to 3 (step S14). The result, texel 0′, is held by the data holding unit 15 (step S33). The counter value is set to 1 (step S35).

Since the counter value is not equal to the repetition count 4 (steps S36 and S37), the texture control unit 10 provides an address offset value of 1 to the data acquisition unit 11 (step S38). Thus, the coordinate calculation units 21-0 to 21-3 calculate four texels 4 to 7, texel 4 with a V coordinate different from that of the sampling point by +1, and the set of three adjacent texels 5 to 7 adjacent to texel 4 in the U axis direction (step S12). The texel acquisition units 22-0 to 22-3 then read the four texels 4 to 7 from the cache memory 12 (step S13). The filtering process unit 13 executes (4×1) filtering on texels 4 to 7 (step S14). The result, texel 4′, is held by the data holding unit 15 (step S33). The data holding unit 15 already holds texel 0′ and thus adds texels 0′ and 4′ together (step S34). The counter value is then set to 2 (step S35).

Since the counter value is not equal to the repetition count 4 (steps S36 and S37), the texture control unit 10 provides an address offset value of 2 to the data acquisition unit 11 (step S38). Thus, the coordinate calculation units 21-0 to 21-3 calculate four texels 8 to 11, texel 8 with a V coordinate different from that of the sampling point by +2 and the set of three adjacent texels 9 to 11 adjacent to texel 8 in the U axis direction (step S12). The texel acquisition units 22-0 to 22-3 then read the four texels 8 to 11 from the cache memory 12 (step S13). The filtering process unit 13 executes (4×1) filtering on texels 8 to 11 (step S14). The result, texel 8′, is held by the data holding unit 15 (step S33). The data holding unit 15 further executes addition of texel 8′ (step S34). The counter value is then set to 3 (step S35).

Since the counter value is not equal to the repetition count 4 (steps S36 and S37), the texture control unit 10 provides an address offset value of 3 to the data acquisition unit 11 (step S38). Thus, the coordinate calculation units 21-0 to 21-3 calculate four texels 12 to 15, texel 12 with a V coordinate different from that of the sampling point by +3, and the set of three adjacent texels 13 to 15 adjacent to texel 12 in the U axis direction (step S12). The texel acquisition units 22-0 to 22-3 then read the four texels 12 to 15 from the cache memory 12 (step S13). The filtering process unit 13 then executes (4×1) filtering on texels 12 to 15 (step S14). The result, texel 12′, is held by the data holding unit 15 (step S33). The data holding unit 15 further executes addition of texel 12′ (step S34). As a result, (4×4) filtering is completed. The counter value is then set to 4 (step S35).

Since the counter value is equal to the repetition count 4, the texture control unit 10 instructs the data holding unit 15 to output its contents to the pixel processing unit 6.

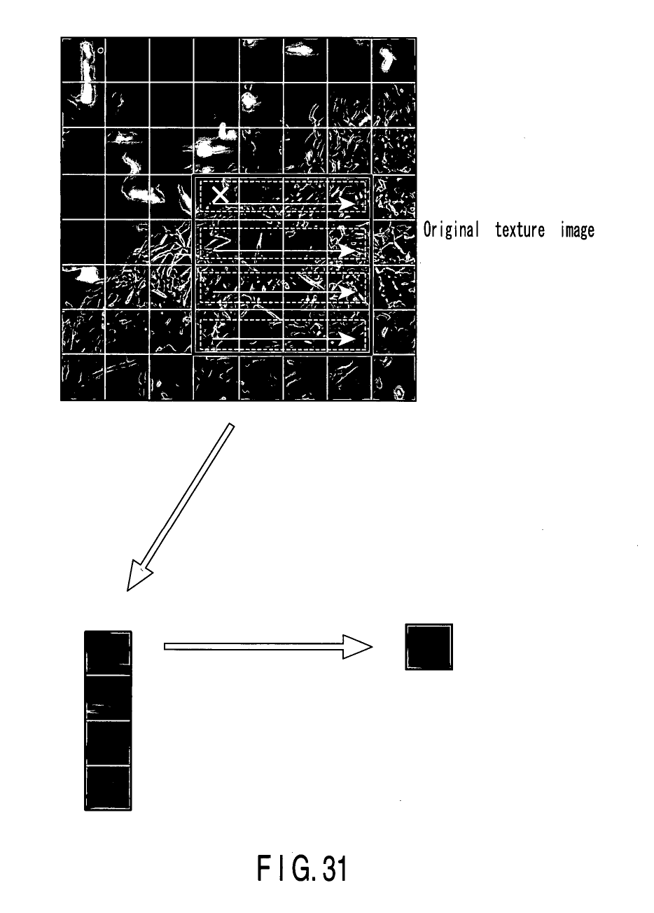

A specific example of FIGS. 29 and 30 will be described with reference to FIG. 31. FIG. 31 is a texture image obtained during a filtering process. As shown in the figure, (4×1) filtering results in a texture image containing four texels and blurred in the horizontal direction. Adding these texels together completes a texture image containing one texel further blurred in the vertical direction.

As described above, the graphic processor in accordance with the second embodiment of the present invention not only Effect 1, described in the first embodiment, but also Effect 2.

(2) The load of texture mapping can be reduced.

With the graphic processor in accordance with the present embodiment, the texture unit 7 receives repetition count from the pixel processing unit 6 as information. The texture unit 7 repeats a texel acquiring process a number of times equal to the repetition count. For example, if texel acquisition in the (4×1) mode is repeated four times, a single texel acquisition instruction provided by the pixel processing unit 6 enables (4×4)=16 texels to be acquired for (4×4) filtering.

To read at least (2×2)texels, the conventional configuration requires the pixel processing unit 6 to give a texture acquisition instruction to the texture unit 7 for each of the texels. However, according to the present embodiment, a single texel acquisition instruction from the pixel processing unit 6 enables the texture unit 7 to execute a plurality of texel acquiring processes. This enables a reduction in the load on the pixel processing unit 6 of the graphic processor for texture mapping.

### Third Embodiment

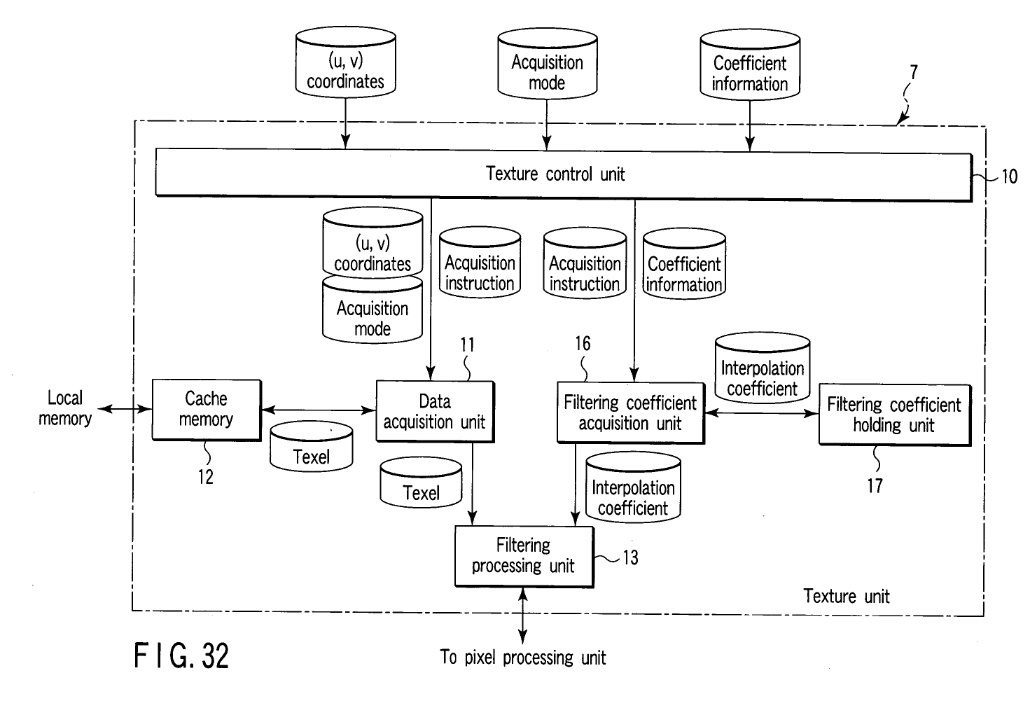

Now, description will be given of a method and device for image processing in accordance with a third embodiment of the present invention. The present embodiment corresponds to the first embodiment which weights texels read by the data acquisition unit 11. FIG. 32 is a block diagram of the texture unit 7 in accordance with the present embodiment. The configuration except for the texture unit 7 is similar to that of the first embodiment and will thus not be described.

As shown in FIG. 32, the texture unit 7 includes the texture control unit 10, the data acquisition unit 11, the cache memory 12, the filtering process unit 13, a filtering coefficient acquisition unit 16, and a filtering coefficient holding unit 17.

The texture control unit 10 receives coefficient information from the pixel processing unit 6. In addition to providing the functions described in the first embodiment, the texture control unit 10 instructs the filtering coefficient acquisition unit 16 to acquire interpolation coefficients based on the coefficient information. The interpolation coefficient will be described below.

The configuration and operation of the data acquisition unit 11 and cache memory 12 are as described in the first embodiment.

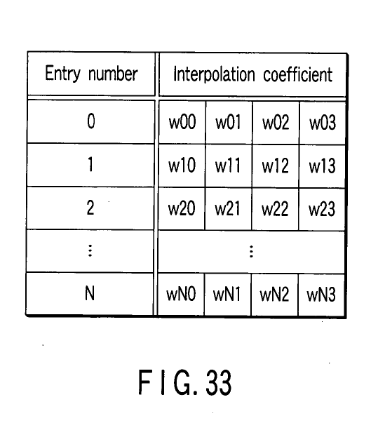

The filtering coefficient holding unit 17 holds interpolation coefficients. The configuration of the filtering coefficient holding unit 17 will be described with reference to FIG. 33. FIG. 33 is a schematic diagram showing the configuration of the filtering coefficient holding unit 17. As shown in the figure, the filtering coefficient holding unit 17 is a memory including a plurality of entries 0 to N (N is a natural number). Each of the entries holds four interpolation coefficients w(n0) to w(n3). Here, n denotes an entry number. The interpolation coefficient is information on weighting of a texel. The entries in the filtering coefficient unit 17 are hereinafter sometimes referred to as coefficient entries.

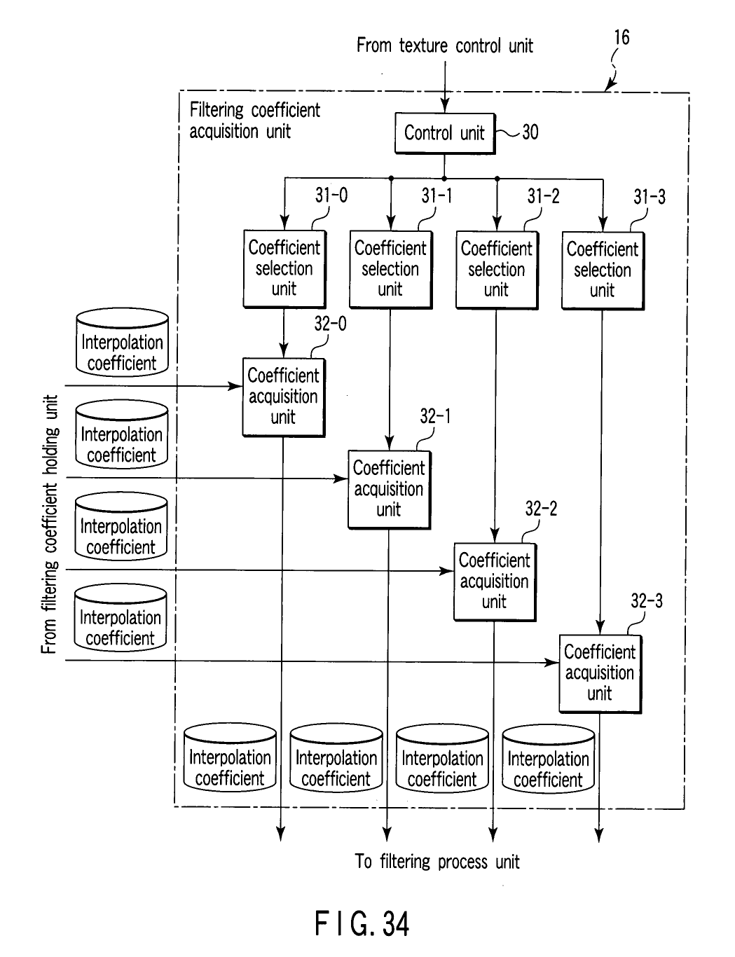

The filtering coefficient acquisition unit 16 reads interpolation coefficients held in any of the entries in the filtering coefficient holding unit 17 in accordance with coefficient information provided by the texture control unit 10. FIG. 34 is a block diagram of the filtering coefficient acquisition unit 16.

As shown in the figure, the filtering coefficient acquisition unit 16 includes a control unit 30, four coefficient selection units 31-0 to 31-3, and four coefficient acquisition units 32-0 to 32-3.

The control unit 30 receives an interpolation coefficient acquisition instruction and coefficient information from the texture control unit 10. The control unit 30 then instructs the coefficient selection units 31-0 to 31-3 to select four interpolation coefficients to be read from the filtering coefficient holding unit 17 in accordance with the input coefficient information.

The coefficient selection units 31-0 to 31-3 correspond to the four texels read by the texel acquisition units 22-0 to 22-3. The coefficient selection units 31-0 to 31-3 select interpolation coefficients to be used for the corresponding texels.

The coefficient acquisition units 32-0 to 32-3 correspond to the coefficient acquisition units 31-0 to 31-3. The coefficient acquisition units 32-0 to 32-3 reads interpolation coefficients from the filtering coefficient holding unit 17 on the basis of the selection made by the coefficient selection units 31-0 to 31-3, specifically, an entry in the filtering coefficient holding unit 17. The read interpolation coefficients are provided to the filtering processing unit 13.

In FIG. 34 and the above description, the four coefficient selection units and the four coefficient acquisition units are provided. However, FIG. 34 only shows the functions of the filtering coefficient acquisition unit 16. The configuration in FIG. 34 may of course be used, but it is also possible to provide only one coefficient selection unit and only one coefficient acquisition unit. That is, any configuration may be used provided that it allows four interpolation coefficients to be read.

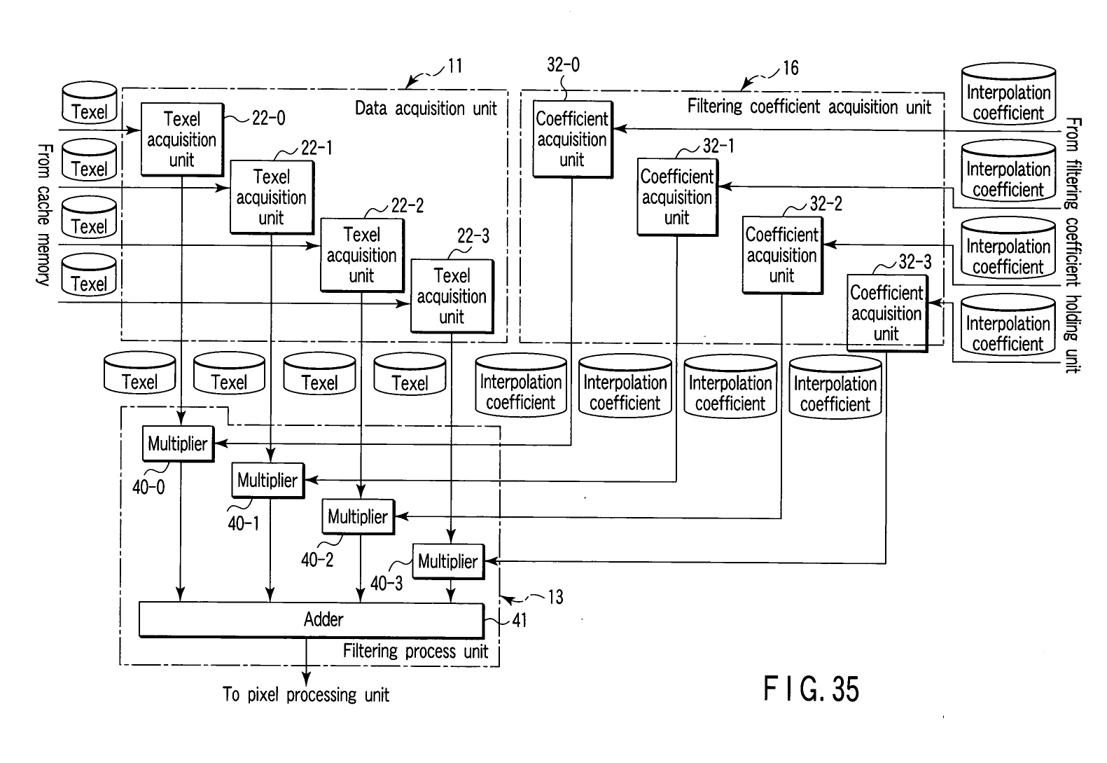

The filtering processing unit 13 multiplies texels obtained by the data acquisition unit 11 by interpolation coefficients obtained by the filtering coefficient acquisition unit 16. The filtering processing unit 13 then adds multiplication results for four pixels together. FIG. 35 is a block diagram of partial areas of the filtering process unit 13, data acquisition unit 11, and filtering coefficient acquisition unit 16.

As shown in the figure, the filtering process unit 13 includes multipliers 40-0 to 40-3 and an adder 41. The multipliers 40-0 to 40-3 multiply texels read by the texel acquisition units 22-0 to 22-3, by interpolation coefficients read by the coefficient acquisition units 32-0 to 32-3. The adder 41 adds the multiplication results from the multipliers 40-0 to 40-3 together. The adder 41 then outputs the addition result to the pixel processing unit 6.

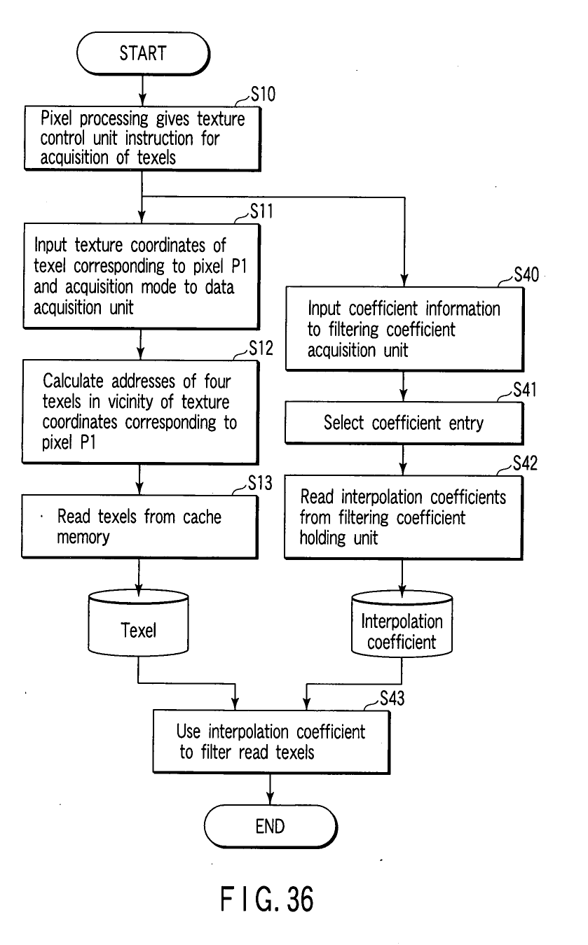

Then, with reference to the flowchart in FIG. 36, description will be given of the operation of the texture unit 7 in the graphic processor 1 configured as described above.

First, the pixel processing unit 6 inputs the XY coordinates of a certain pixel Pi to the texture control unit 10. The pixel processing unit 6 also gives the texture control unit 10 an instruction for acquisition of four texels corresponding to the pixel P1 (step S10). In this case, the pixel processing unit 6 inputs not only the acquisition mode but also coefficient information to the texture control unit 10. Then, the texture control unit 10 executes the processing in steps S11 to S13, described in the first embodiment, to read four pixels.

The texture control unit 10 provides the filtering coefficient acquisition unit 16 with the coefficient information provided by the pixel processing unit 6 (step S40). Then, on the basis of the coefficient information, the coefficient selection units 31-0 to 31-3 select any of coefficient entries in the filtering coefficient holding unit 17 (step S41). The coefficient acquisition units 32-0 to 32-3 then reads interpolation coefficients from the coefficient entry selected by the coefficient selection units 31-0 to 31-3 (step S42).

Then, the filtering process unit 13 uses the four interpolation coefficients read by the filtering coefficient acquisition unit 16 to execute a filtering process on the four texels read by the data acquisition unit 11 (step S43).

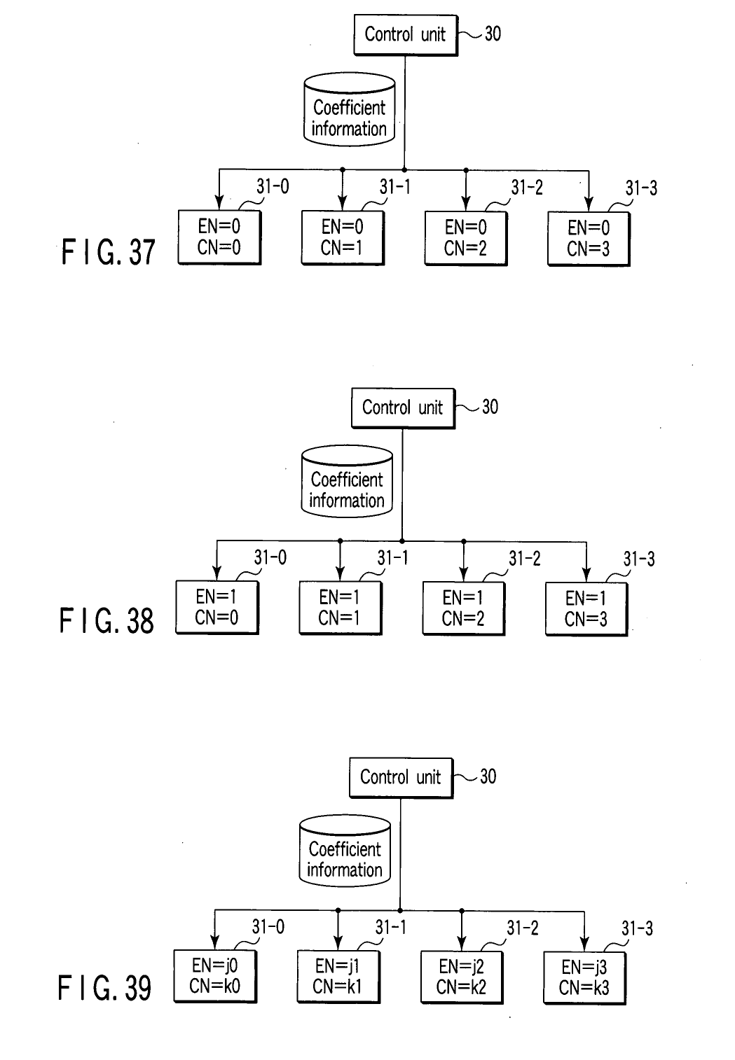

A specific example of the above step S41 will be described with reference to FIGS. 37 to 39. FIGS. 37 to 39 are each a block diagram of a partial area of the filtering coefficient acquisition unit 16. FIG. 37 shows the case where a coefficient entry=0 is selected. FIG. 38 shows the case where a coefficient entry=1 is selected.

First, as shown in FIG. 37, the coefficient selection units 31-0 to 31-3 select 0 as a coefficient entry EN. In this case, the four interpolation coefficients contained in the selected coefficient entry are all selected. These interpolation coefficients are denoted by coefficient numbers CN. It is assumed that the data held by the filtering coefficient holding unit 17 is as shown in FIG. 33. Then, in FIG. 37, the coefficient selection units 31-0 to 31-3 instruct the coefficient acquisition units 32-0 to 32-3 to read interpolation coefficients w00 to w03, respectively, from the coefficient entry 0.

In FIG. 38, the coefficient selection units 31-0 to 31-3 instruct the coefficient acquisition units 32-0 to 32-3 to read interpolation coefficients w00 to w03, respectively, from the coefficient entry 1.

Now, an example shown in FIG. 39 will be described. FIG. 39 generalizes the examples shown in FIGS. 37 and 38. As shown in the figure, each of the coefficient selection units 31-0 to 31-3 selects any of the coefficient entries EN=j0 to j3 in the filtering coefficient holding unit 17. Each of the coefficient selection units 31-0 to 31-3 further uses the coefficient numbers CN=k0 to k3 to select any of the interpolation coefficients in the selected coefficient entry. In this case, for j0 to j3 any of which is selected by each of the coefficient selection units 31-0 to 31-3, different coefficient entries EN or the same coefficient entry EN may be selected. For k0 to k3 any of which is selected by each of the coefficient selection units 31-0 to 31-3, different coefficient numbers CN or the same coefficient number CN may be selected. For example, it is assumed that the coefficient selection units 31-0 to 31-3 select the coefficient entries EN=0 to 3, respectively, and the same coefficient number CN. In this case, the coefficient acquisition units 32-0 to 32-3 read interpolation coefficients w00, w10, w20, and w30, respectively.

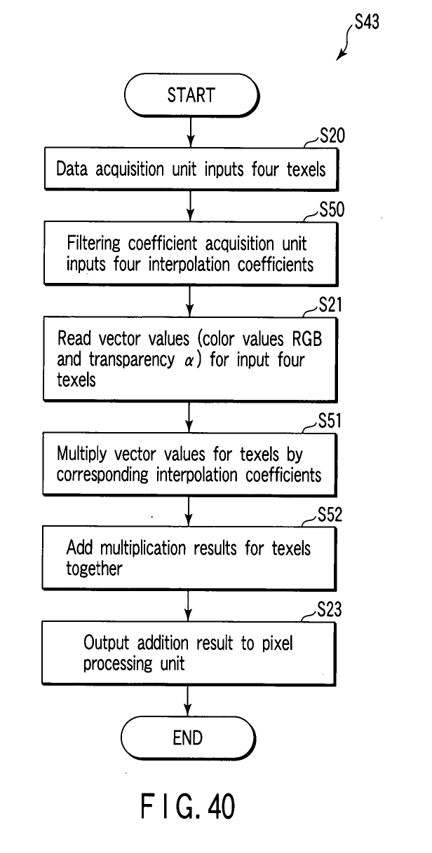

Now, a filtering process (step S43) executed by the filtering process unit 13 will be described in detail with reference to FIG. 40. FIG. 40 is a flowchart of a filtering process S43 in accordance with the present embodiment. First, four texels read by the data acquisition unit 11 are input to the filtering process unit 13 (step S20). By way of example, it is assumed that the texel acquisition units 22-0 to 22-3 read texels 0 to 3, respectively. Four interpolation coefficients read by the filtering coefficients acquisition unit 16 are input to the filtering process unit 13 (step S50). By way of example, it is assumed that the coefficient acquisition units 32-0 to 32-3 read interpolation coefficients w00, w01, w02, and w03, respectively.

Then, the multipliers 40-0 to 40-3 in the filtering process unit 13 read the vector values of texels 0 to 3 (step S21). The multipliers 40-0 to 40-3 subsequently multiply the vector values of texels 0 to 3 by the corresponding interpolation coefficients w00, w01, w02, and w03, respectively (step S51). The adder 41 then adds the multiplication results from the multipliers 40-0 to 40-3 together (step S52). The addition result corresponds to the texel resulting from the filtering process. The adder 41 outputs the addition result to the pixel processing unit 6 (step S23).

That is, the filtering process unit 13 executes the following equation to output the result to the pixel processing unit 6.
V0·w0+V1·w1+V2w2+V3·w3
V0 to V3 denote vector values read by the texel acquisition units 22-0 to 22-3. w0 to w3 denote interpolation coefficients read by the coefficient acquisition units 32-0 to 32-3, respectively.

As described above, the graphic processor in accordance with the third embodiment of the present invention exerts not only Effect 1, described in the first embodiment, but also Effect 3.

(3) The degree of freedom of a filtering process can be increased (2).

In the graphic processor in accordance with the present embodiment, the filtering coefficient holding unit 17 holds information (interpolation coefficients) on weighting of read texels. The filtering coefficient acquisition unit 16 reads interpolation coefficients in accordance with texels read by the data acquisition unit 11. The filtering process unit 13 uses the read interpolation coefficients to execute a filtering process. Consequently, if a plurality of texels are used to execute a filtering process, various weightings can be set for the plurality of pixels, enabling an increase in the degree of freedom of a filtering process.

Further, according to the present embodiment, the filtering coefficient acquisition unit 16 is provided in the texture unit 7. This enables a process for acquiring filtering coefficients to be completed within the texture unit 7. Therefore, a filtering process can be executed at a high speed without increasing the load on the pixel processing unit 6.

### Fourth Embodiment

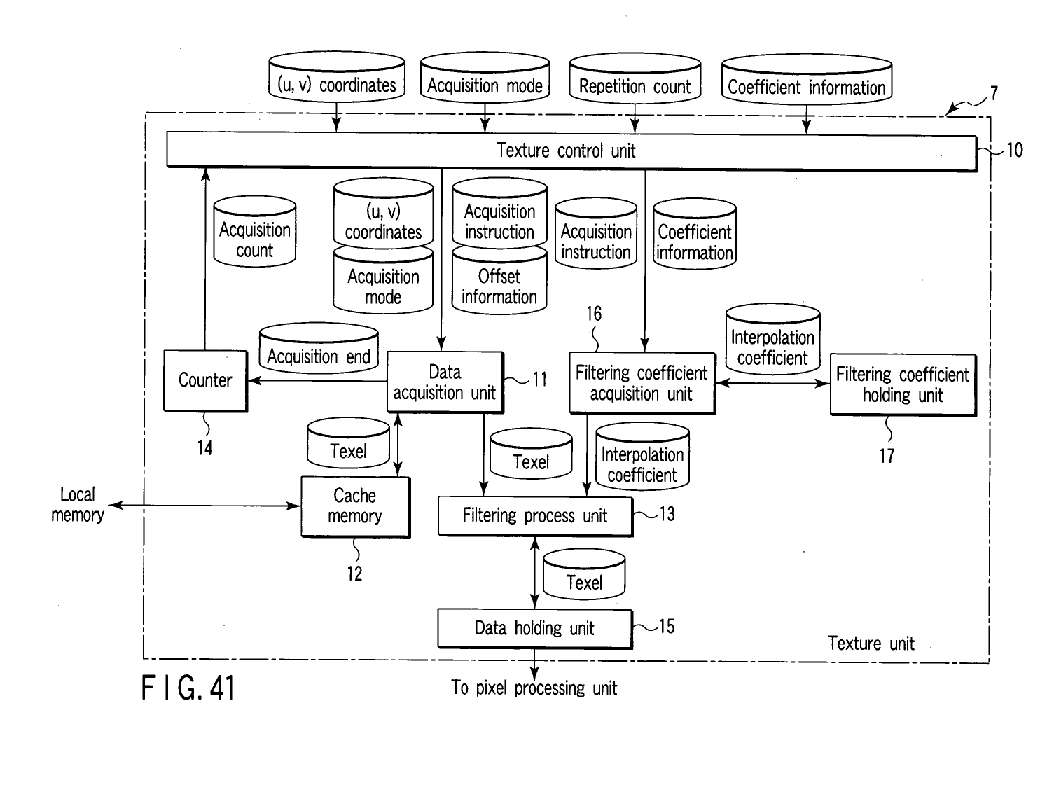

Now, description will be given of a method and device for image processing in accordance with a fourth embodiment of the present invention. The present embodiment corresponds to a combination of the second and third embodiments. FIG. 41 is a block diagram of the texture unit 7 in accordance with the present embodiment. The configuration except for the texture unit 7 is similar to that of the first embodiment and will thus not be described.

As shown in FIG. 41, the texture unit 7 includes the texture control unit 10, the data acquisition unit 11, the cache memory 12, the filtering process unit 13, the counter 14, the data holding unit 15, the filtering coefficient acquisition unit 16, and the filtering coefficient holding unit 17.

The texture control unit 10 receives the UV coordinates, acquisition mode, repetition count, and coefficient information, described in the above embodiments, from the pixel processing unit 6. Then, as described in the second embodiment, the texture control unit 10 issues an instruction for texel acquisition to the data acquisition unit 11 a number of times equal to the repetition count. The texture control unit 10 also issues an instruction for interpolation coefficient acquisition to the filtering coefficient acquisition unit 16 a number of times equal to the repetition count.

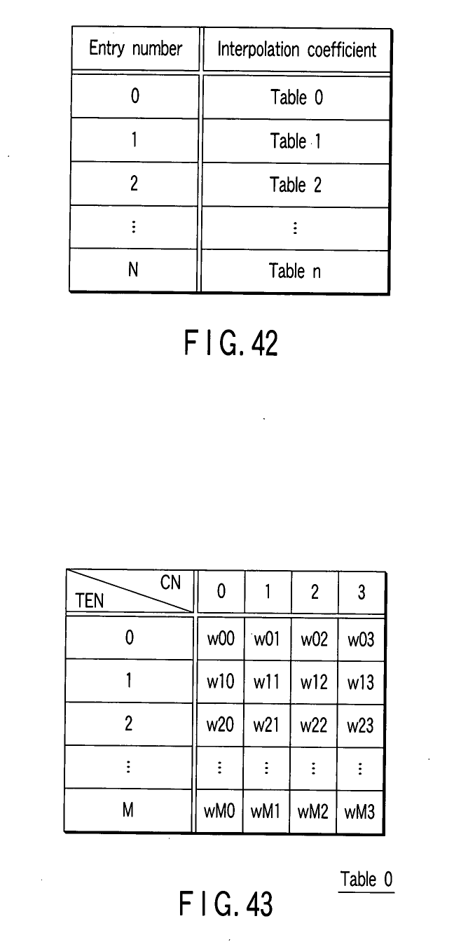

FIG. 42 is a schematic diagram showing the configuration of the filtering coefficient holding unit 17. As shown in the figure, the filtering coefficient holding unit 17 is a memory including a plurality of entries 0 to N. The entries hold respective interpolation coefficient tables 0 to n. Here, n denotes an entry number. The interpolation coefficient table will be described with reference to FIG. 43. FIG. 43 is a schematic diagram of the interpolation coefficient table 0. As shown in the figure, the interpolation coefficient table 0 includes a plurality of entries 0 to M (hereinafter referred to as in-table entries TEN). Each of the entries holds interpolation coefficients corresponding to the coefficient numbers CN=0 to 3.

The filtering coefficient acquisition unit 16 selects any of the interpolation coefficient table on the basis of coefficient information. Moreover, interpolation coefficients are selected from the selected interpolation coefficient table in accordance with the repetition count i.

The remaining part of the configuration is as described in the first to third embodiments.

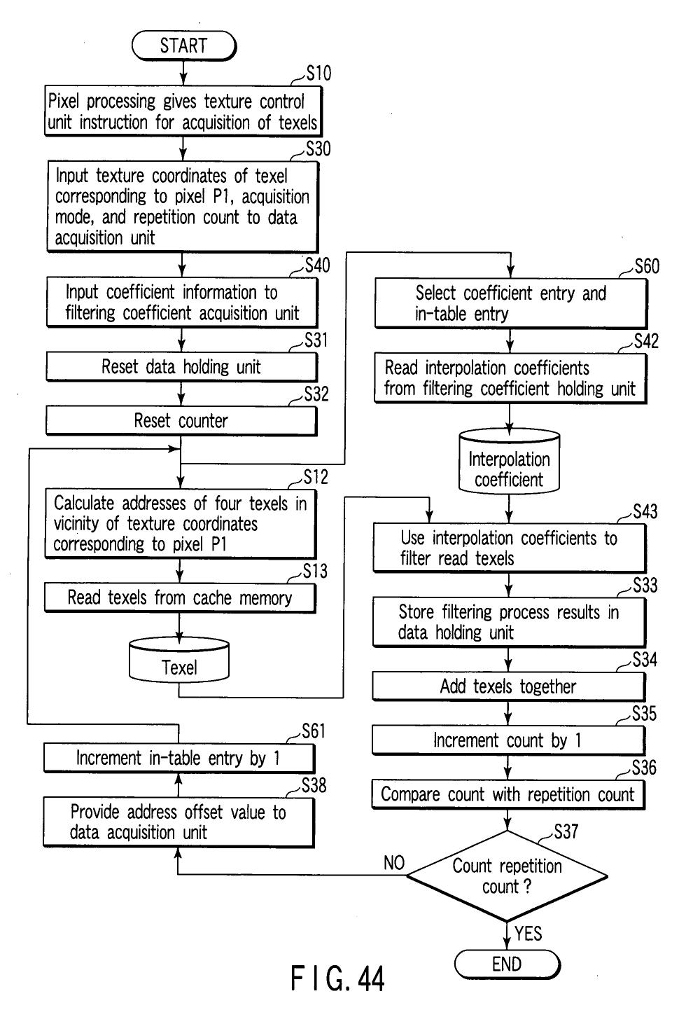

Now, with reference to the flowchart in FIG. 44, description will be given of the operation of the texture unit 7 in the graphic processor 1 configured as described above.

First, the pixel processing unit 6 inputs the XY coordinates of a certain pixel P1 to the texture control unit 10. The pixel processing unit 6 also gives the texture control unit 10 an instruction for acquisition of four texels corresponding to the pixel P1 (step S10). In this case, the pixel processing unit 6 also inputs the acquisition mode, repetition count, and coefficient information to the texture control unit 10. Then, the texture control unit 10 calculates texel coordinates corresponding to the pixel P1. The texture control unit 10 provides the data acquisition unit 11 with the calculated texel coordinates and the acquisition mode and instructs the data acquisition unit 11 to acquire texels (step S30). In this case, the texture control unit 10 may also provide the repetition count to the data acquisition unit 11. At the same time, the texture control unit 10 provides the filtering coefficient acquisition unit 16 with the coefficient information provided by the pixel processing unit 6 (step S40). The texture control unit 10 further resets the data in the data holding unit 15 (step S31) and resets the counter value in the counter 14 (step S32).

Then, the data acquisition unit 11 selects four texels in the vicinity of the texel coordinates (sampling point) corresponding to the pixel P1 in accordance with the acquisition mode and calculates their addresses (step S12). The data acquisition unit 11 further reads texels from the cache memory 12 on the basis of the addresses calculated in step S12 (step S13).

Each of the coefficient selection units 31-0 to 31-3 selects any of the coefficient entries in the filtering coefficient holding unit 17 on the basis of the coefficient information. Each of the coefficient selection units 31-0 to 31-3 further selects any of the in-table entries (step S60). Then, the coefficient acquisition units 32-0 to 32-3 read interpolation coefficients from the in-table entries selected by the coefficient selection units 31-0 to 31-3, respectively (step 42). Subsequently, the processing in steps S43 and S33 to S38, described in the second and third embodiments, is executed. That is, the filtering process unit 13 uses the four interpolation coefficients read by the filtering coefficient acquisition unit 16 to execute a filtering process on the four texels read by the data acquisition unit 11 (step S43). The result is held in the data holding unit 15 (step S33). The data holding unit 15 adds the newly provided texels to the already held data (step S34). However, immediately after resetting, the data holding unit 31 holds the input texels as they are. Then, the counter value is compared with the repetition count (step S36). If the counter value has reached the repetition count (step S37, YES), the process ends. If the counter value has not reached the repetition count (step S37, NO), the texture control unit 10 provides an address offset value to the data acquisition unit, while instructing the data acquisition unit 11 to acquire texels again (step S38). At this time, the texture processing unit 10 newly adds an instruction for incrementation of the in-table entry TEN by +1, to the coefficient information (step S61).

The processing in steps S12, S13, S60, S42, S43, S33 to S38, and S61 is repeated until the counter value reaches the repetition count. In this case, the address calculation in step S12 uses the address offset value provided in step S38. The selection of the in-table entry TEN in step S60 uses the in-table entry TEN provided in step S61.

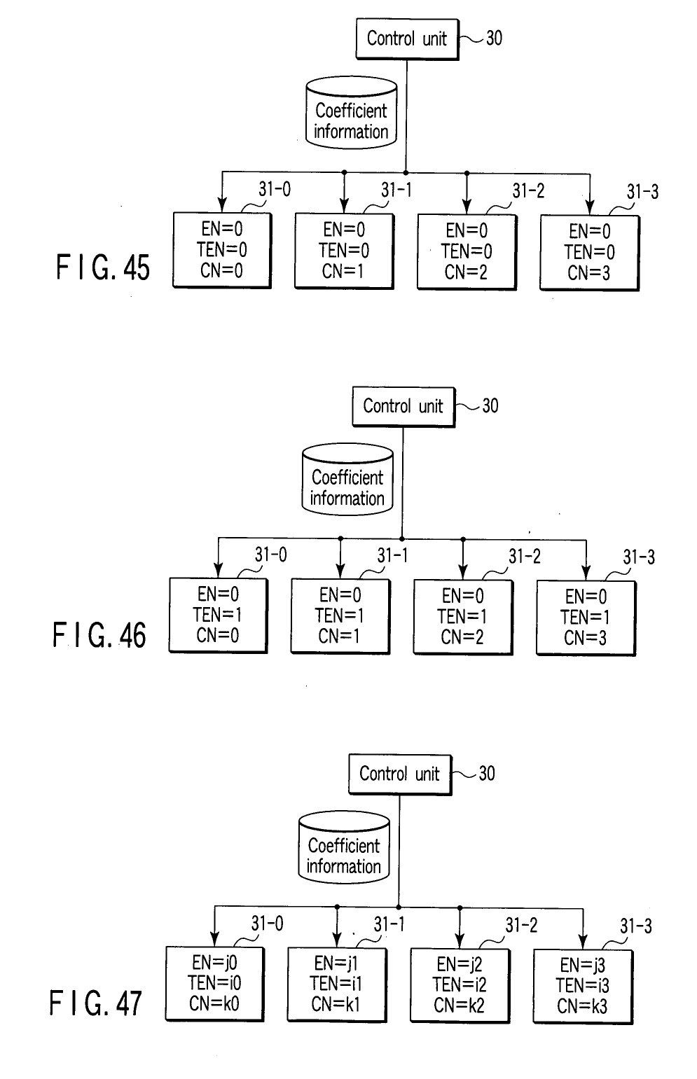

Step S60 will be described in detail with reference to FIGS. 45 to 47. FIGS. 45 and 46 are each a block diagram showing how a partial area of the filtering coefficient acquisition unit 16 operates when the coefficient entry =0 is selected. FIG. 45 shows a case with a counter value of zero (i=0). FIG. 46 shows a case with a counter value of 1 (i=1).

First, as shown in FIG. 45, the coefficient selection units 31-0 to 31-3 select 0 as a coefficient entry EN. The coefficient selection units 31-0 to 31-3 select an in-table entry TEN in accordance with the repetition count. Specifically, an in-table entry TEN with a number equal to the counter value is selected. Accordingly, with a counter value of zero, the coefficient selection units 31-0 to 31-3 select 0 as an in-table entry TEN. Further, it is assumed that the coefficient selection units 31-0 to 31-3 select coefficient numbers CN=0 to 3, respectively. Then, the coefficient selection units 31-0 to 31-3 select the interpolation coefficient table 0 in the filtering coefficient holding unit 17. Furthermore, it is assumed that the interpolation coefficient table 0 is as shown in FIG. 43. Then, the coefficient selection units 31-0 to 31-3 instruct the coefficient acquisition units 32-0 to 32-3 to read the interpolation coefficients w00 to w03 from the in-table entry TEN=0.

In FIG. 46, since the counter value is 1, the coefficient selection units 31-0 to 31-3 instruct the coefficient acquisition units 32-0 to 32-3 to read interpolation coefficients w10 to w13 from the in-table entry TEN=0.

Now, the example shown in FIG. 47 will be described. FIG. 47 generalizes the examples shown in FIGS. 45 and 46. As shown in the figure, the coefficient selection units 31-0 to 31-3 select any coefficient entry EN=j in the filtering coefficient holding unit 17 on the basis of input coefficient information. That is, the interpolation coefficient table j is selected. Further, the in-table entry TEN=i is selected from the selected interpolation coefficient table j in accordance with the repetition count i. Furthermore, an interpolation coefficients to be selected from the selected in-table entry is determined on the basis of the coefficient number CN=k. Of course, the coefficient selection units 31-0 to 31-3 may select coefficient entries EN=j0 to j3, respectively, and further select coefficient numbers CN=k0 to k3, respectively. This is as described in the third embodiment.

As described above, the graphic processor in accordance with the fourth embodiment of the present invention exerts Effects 1 to 3, described in the first to third embodiments.

### Fifth Embodiment

Now, description will be given of a method and device for image processing in accordance with a fifth embodiment of the present invention. The present embodiment relates to a first applied example of the graphic processor described in the fourth embodiment and to a process executed when an object is irradiated with light.

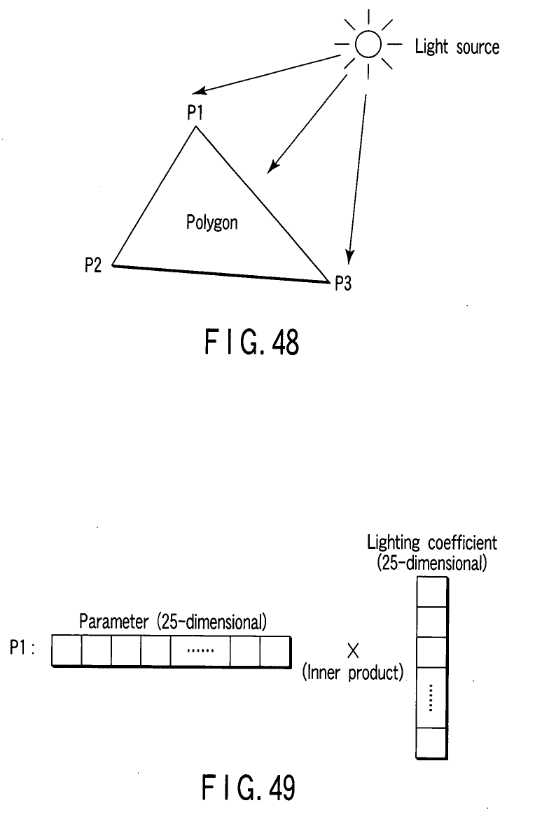

For example, it is assumed that a polygon is irradiated with light from a light source as shown in the schematic diagram in FIG. 48. In this case, an image drawing process is executed by calculating the inner products of parameters for the vertices P1 to P3 of the polygon and coefficients for the light source (these are hereinafter referred to as lighting coefficients). The parameter for each of the vertices of the polygon is, for example, 25-dimensional and can be expressed as a (25×1) matrix. Like P1 to P3, the lighting coefficient is 25-dimensional and can be expressed as a (1×25) matrix.

Thus, as shown in a schematic diagram in FIG. 49, a drawing process for light is executed by calculating the inner products of the (25×1) matrix for each of the vertices P1 to P3 and the (1×25) matrix for the lighting coefficients for the light source. FIG. 49 shows only the process for the vertex P1, but similar calculations are executed for the vertices P2 and P3.

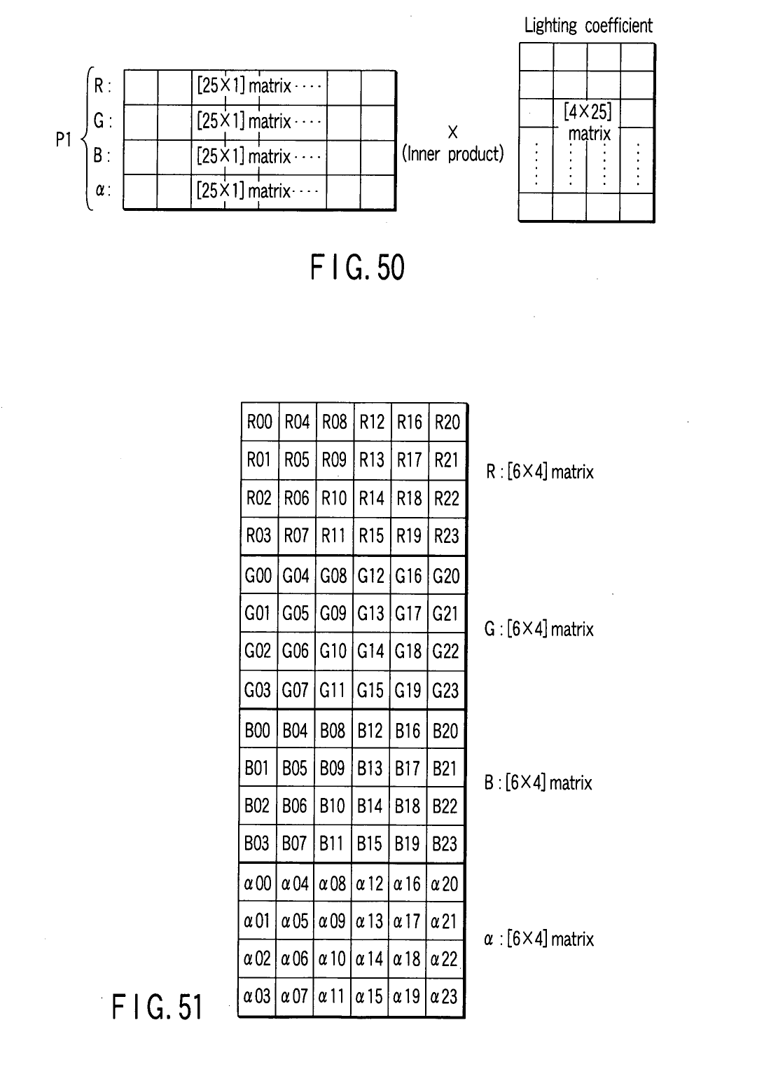

In this case, the parameters for each of the vertices P1 to p3 of the polygon may be expanded to express the vertex as a (25×4) matrix having 25 parameters for each of R, G, B, and a. In this case, the light coefficients are also expanded to at least a (4×25) matrix. Then, as shown in a schematic diagram in FIG. 50, the inner product of the (25×4) matrix and the (4×25) matrix need to be calculated for each of the vertices P1 to P3.

In this case, the (25×4) matrix for each of the vertices P1 to P3 and the (4×25) matrix for the lighting coefficients are set to be a texture and an interpolation coefficient, respectively. Then, the pixel processing unit 6 provides the texture unit 7 with a texel address, that is, the address of a parameter corresponding to the first column and first row of the parameters for the vertex and sets the acquisition mode and the repetition count to be (1×4) and 25, respectively. The pixel processing unit 6 thus instructs the texture unit 7 to acquire texels (that is, parameters for P1 to P3). In this case, the pixel processing unit 6 instructs the texture unit 7 to execute a filtering process using the lighting coefficients, given as coefficient information. The process described in the fourth embodiment is subsequently executed.

A specific example will be described below. FIG. 51 is a schematic diagram in which the parameters for the vertex P1 are set to be a texture. As shown in the figure, the red component R, green component G, blue component B, and transparency component α of the vertex P1 each have (6×4)=24 components. The components of the red component R are called R00 to R23. The components of the green component G are called G00 to G23. The components of the blue component B are called B00 to B23. The components of the transparency component α are called α00 to α23.

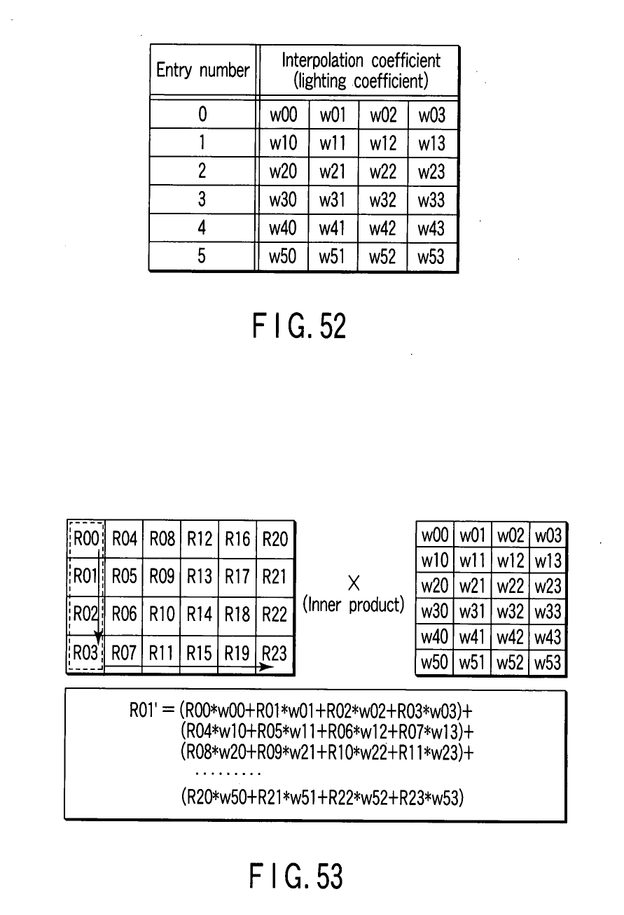

FIG. 52 shows lighting coefficients set to be interpolation coefficients. As shown in the figure, four lighting coefficients are stored for each of the six entries 0 to 5. Lighting coefficients w00, w01, w02, and w03 are stored for the entry 0. Lighting coefficients w10, w11, w12, and w13 are stored for the entry 1. Lighting coefficients w50, w51, w52, and w53 are stored for the entry 5.

Then, the texture unit 7 first sets a leading address and the repetition count to be R00 and 6, respectively, for the red component to execute (1×4) filtering, described in the fourth embodiment. This is shown in FIG. 53. As shown in the figure, the data acquisition unit 11 reads the first column R00 to R03 for the red component. The filtering coefficient acquisition unit 16 reads the interpolation coefficients w00 to w03. The filtering process unit 13 calculates (R00·w00+R01·w01+R02·w02+R03·w03). The data acquisition unit 11 then reads R04 to R07, the second column for the red component. The filtering coefficient acquisition unit 16 reads the interpolation coefficients w10 to w13. The filtering process unit 13 calculates (R04·w10+R05·w11+R06·w12+R07·w13). The texture unit 7 repeats the above calculation until the last column (R20 to R23) of the (6×4) matrix for the red component R. The texture unit 7 then outputs the sum of the results.

Similar calculations are executed for the green component G, the blue component B, and the transparency component α.

The graphic processor in accordance with the present embodiment exerts not only Effects 1 to 3, described in the above embodiments, but also Effect 4. (4) Matrix calculations can be executed at a high speed.

As described above, an objected irradiated with light is expressed by matrix calculations. However, more flexible expression of the object requires an enormous number of elements for the matrix, drastically increasing the burden of the matrix calculations.

However, the configuration in accordance with the present embodiment sets the parameters for the vertices of the polygon to be a texture, sets the lighting coefficients to be interpolation coefficients, and repeats a filtering process in the (1×4) mode. Accordingly, the pixel processing unit 6 can executed all matrix calculations simply by specifying the leading element of the parameters for each vertex and providing lighting coefficient acquisition information and the repetition count. This enables the matrix calculations to be executed at a high speed.

The above embodiment has been described citing the inner product of the parameters for the vertex and the lighting coefficients as an example. However, the present embodiment is not limited to this and is applicable to any cases involving inner product calculations for a (4×L) matrix (L is a natural number) and an (L×4) matrix. Of course, the (4×1) mode allows the above embodiment to be applied to inner product calculations for an (L×4) matrix and a (4×L) matrix.

### Sixth Embodiment

Now, description will be given of a method and device for image processing in accordance with a sixth embodiment of the present invention. The present embodiment relates to a second applied example of the graphic processor described in the fourth embodiment and uses the texture unit as a deblocking filter.

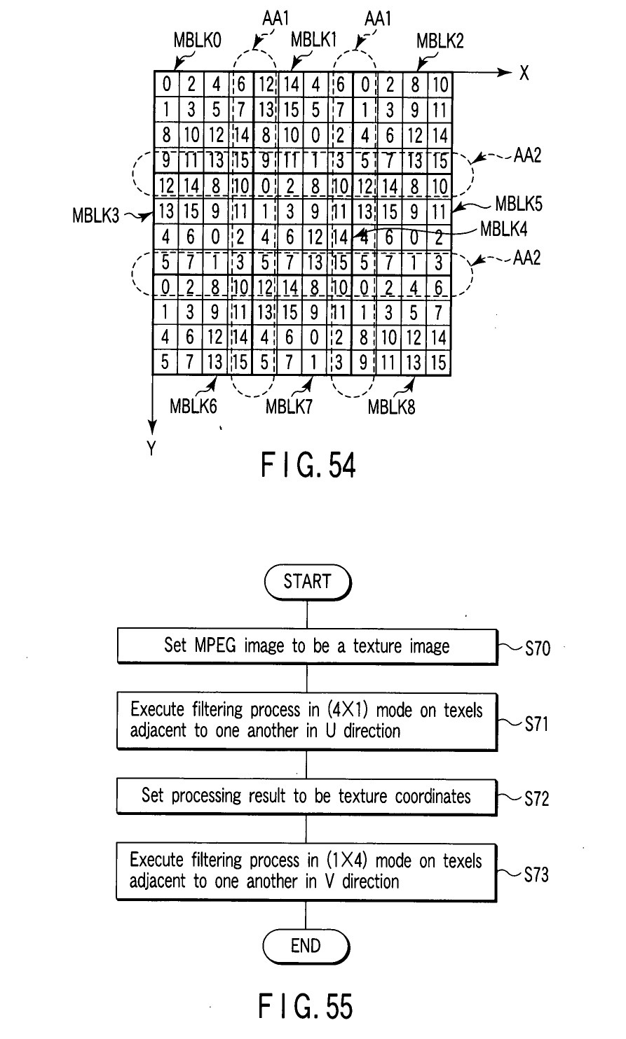

FIG. 54 is a schematic diagram of a Moving Picture Experts Group (MPEG) image. It is assumed that the MPEG image is drawn at two-dimensional XY coordinates as shown in the figure. For simplification, it is assumed that an image is drawn using (12×12) pixels. Image compressing techniques such as MPEG divides an image into blocks each of (8×8) pixels or (4×4) pixels. Then, a compressing process such as DCT is executed on each of the areas resulting from the division. These areas are hereinafter referred to as pixel blocks MBLK. In the present embodiment, it is assumed that the pixel block MBLK contains (4×4) pixels.

With the above compressing method, the compressing scheme does not take pixel information on different pixel blocks into account. Consequently, a pixel brightness artifact may occur between adjacent blocks (areas AA1 and AA2 in FIG. 54). This is usually called block noise. The present embodiment uses the texture unit 7 of the graphic processors described in the seventh and fourth embodiments, as a deblocking filter that reduces block noise.

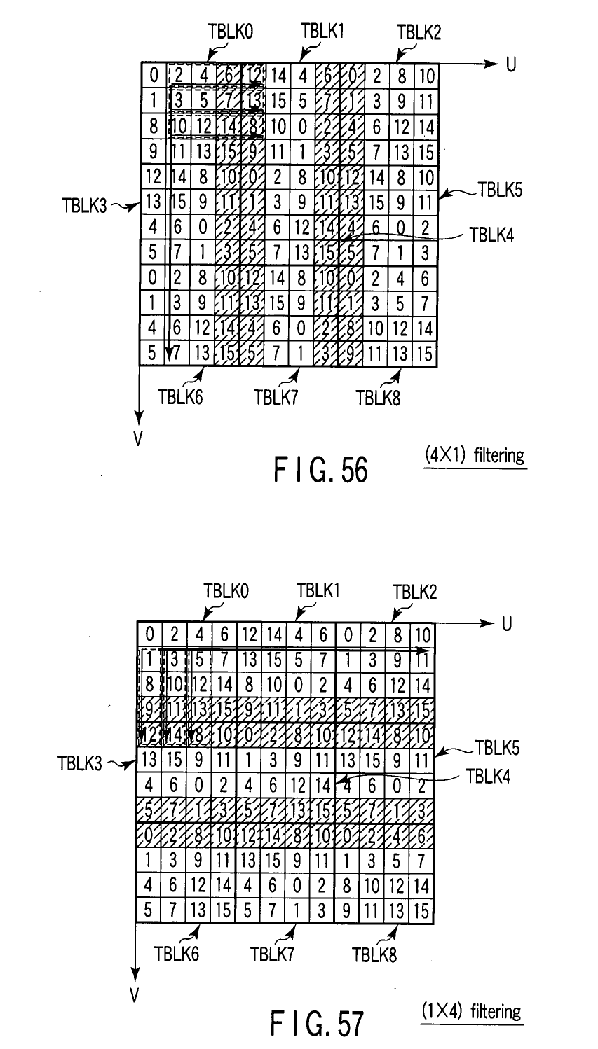

FIG. 55 is a flowchart of a block noise reducing process using the texture unit 7. As shown in the figure, first, an MPEG image is set to be a texture image (step S70). Then, texels adjacent to each other across a pixel block boundary in the U direction are filtered in the (4×1) mode (step S71). This is shown in FIG. 56. FIG. 56 is a conceptual diagram of a texture. In FIG. 56, shaded texels are to be filtered. FIG. 56 shows that only texels 6, 7, and 14 in texel block TBLK0 are filtered.

As shown in the figure, to filter for texel 6 in texel block TBLK0, for example, texels 2, 4, and 6 are read from texel block TBLK0, texel 12 is read from texel block TBLK1, and the read texels are filtered. To filter for texel 7 in texel block TBLK0, for example, texels 3, 5, and 7 are read from texel block TBLK0, texel 13 is read from texel block TBLK1, and the read texels are filtered. To filter for texel 14 in texel block TBLK0, for example, texels 10, 12, and 14 are read from texel block TBLK0, texel 8 is read from texel block TBLK1, and the read texels are filtered. As described above, (4×1) filtering is executed on each of the 12 texels having the same U coordinate as that of texel 6 in texel block TBLK0. However, texel acquisition is not limited to this. For example, to filter for texel 6 in texel block TBLK0, texels 4 and 6 may be read from texel block TBLK0 and texels 12 and 14 may be removed from texel block TBLK1.

Then, a filtering process in the (4×1) mode is executed on each of the texels having the same U coordinate as that of texel 12 in texel block TBLK1. Further, a filtering process in the (4×1) mode is executed on each of the texels having the same U coordinate as that of texel 6 in texel block TBLK1. Finally, a filtering process in the (4×1) mode is executed on each of the texels having the same U coordinate as that of texel 0 in texel block TBLK2.

Once the above filtering processes are finished, the result is set to be a new texture image (step S72). Then, a filtering process in the (1×4) mode is executed on texels adjacent to each other across a pixel block boundary in the V direction (step S73). This is shown in FIG. 57. FIG. 57 is a conceptual diagram of a texture. In FIG. 57, shaded texels are to be filtered. FIG. 57 shows that only texels 9, 11, and 13 in texel block TBLK0 are filtered.

As shown in the figure, to filter for texel 9 in texel block TBLK0, for example, texels 1, 8, and 9 are read from texel block TBLK0, texel 12 is read from texel block TBLK3, and the read texels are filtered. To filter for texel 11 in texel block TBLK0, for example, texels 3, 10, and 11 are read from texel block TBLK0, texel 14 is read from texel block TBLK3, and the read texels are filtered. To filter for texel 13 in texel block TBLK0, for example, texels 5, 12, and 13 are read from texel block TBLK0, texel 8 is read from texel block TBLK3, and the read texels are filtered. As described above, (4×1) filtering is executed on each of the 12 texels having the same V coordinate as that of texel 9 in texel block TBLK0. However, texel acquisition is not limited to this. For example, to filter for texel 9 in texel block TBLK0, texels 8 and 9 may be read from texel block TBLK0 and texels 12 and 13 may be read from texel block TBLK3.

Then, a filtering process in the (1×4) mode is executed on each of the texels having the same V coordinate as that of texel 12 in texel block TBLK3. Further, a filtering process in the (1×4) mode is executed on each of the texels having the same V coordinate as that of texel 5 in texel block TBLK3. Finally, a filtering process in the (1×4) mode is executed on each of the texels having the same U coordinate as that of texel 0 in texel block TBLK6.

The above process results in an MPEG image with reduced block noise.

The graphic processor in accordance with the present embodiment exerts not only Effects 1 to 3, described in the above embodiments, but also Effect 5.

(5) A reduction in block noise can be achieved at a high speed without increasing the required amount of hardware.

A deblocking filter or the like is specified in a compression codec such as H. 264 as a technique for reducing block noise. However, if a general-purpose CPU having no special hardware is used for processing, it must provide a high throughput, which may account for about 50% of the total amount of calculation for decoding. Thus, new hardware may be provided in order to reduce block noise. However, this may disadvantageously increase the cost and size of the graphic processor.

However, the graphic processor in accordance with the present embodiment uses the texture unit 7 as a blocking filter. This enables a reduction in the load of a block noise reducing process on the pixel processing unit 6, enabling high-speed processing. The use of the texture unit 7 makes it possible to prevent an increase in the required amount of hardware.

### Seventh embodiment

Now, description will be given of a method and device for image processing in accordance with a seventh embodiment of the present invention. The present embodiment relates to a third applied example of the graphic processors described in the first to fourth embodiments and is applied to a depth of field effect. The depth of field effect in computer graphics means simulation of a defocusing and blurred image taken with a real camera. Exerting the depth of field effect on computer graphics images enables scenes with a depth feel to be expressed.

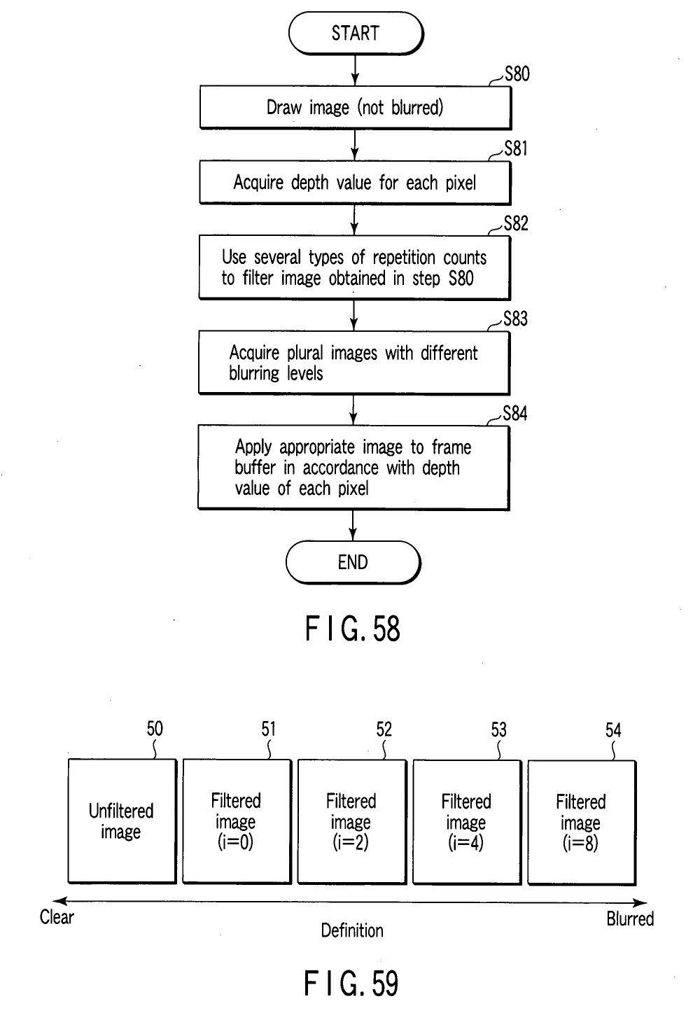

FIG. 58 is a flowchart of a process for the depth of field effect. As shown in the figure, first, the pixel processing unit 6 draws an image (step S80). In this case, texture mapping is executed by reading a texture from the texture unit 7. The texture used is not subjected to the blurring process described in the above embodiments. The image drawing in step S80 provides a depth value for each pixel (step S81). The depth value indicates the position of an object in the image. A larger depth value indicates that the object is located deeper in the image, in other words, at a distance.

Then, the image drawn in step S80 is set to be a texture image, and several types of repetition counts are used to execute a filtering process (step S82). This provides a plurality of image with different blur levels (step S83). FIG. 59 is a conceptual diagram showing texture images and their definitions. As shown in the figure, a plurality of images are prepared, including an unfiltered image 50 and images 51 to 54 filtered at a repetition count i=0, 2, 4, or 8. Obviously, a larger repetition count leads to a more blurred image.

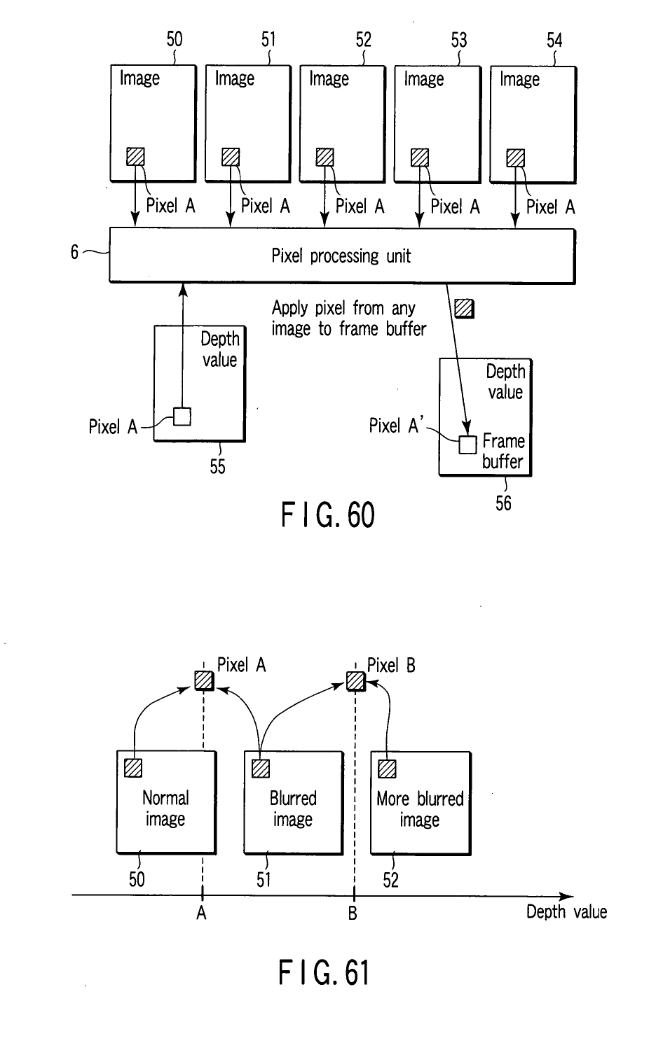

Then, the pixel processing unit 6 applies one of the corresponding pixels in the images 50 to 54 which is appropriate on the basis of the depth value of the pixel, to the frame buffer to draw an image (step S84). Of course, an image with a larger depth value allows a more blurred texture image to be selected. FIG. 60 is a schematic view of the processing in step S60. As shown in the figure, the pixel processing unit 6 first reads the depth value for the position corresponding to a pixel A, from a depth value 55. The pixel processing unit 6 then reads one of the pixels A in the image 50 to 54 which is appropriate for the read depth value. The pixel processing unit 6 then applies the read pixel A to a pixel A′ located at the same position as that of the pixel A in the frame buffer 56.

FIG. 61 shows how the pixel processing unit 6 generates a pixel to be applied to the frame buffer 56. As shown in the figure, if the depth value of the pixel A corresponds to a position slightly deeper than the most front surface of the image, linear interpolation is executed using the unfiltered image 50 and the blurred image 51. The result is the pixel A to be applied to the frame buffer 56. For a pixel B with a much larger depth value than the pixel A, linear interpolation is executed using the blurred image 51 and the more blurred image 52 to generate a pixel B to be applied to the frame buffer 56.

The graphic processor in accordance with the present embodiment exerts not only Effects 1 to 3, described in the above embodiments, but also Effect 6.

(6) The depth of field effect can be easily exerted on computer graphics image.

The present embodiment provides a plurality of images with different definitions and selects one of the images in accordance with the depth value. In this case, images with different definitions can be created simply by varying the repetition count for filtering. No other special process is required. This enables the depth of field effect to be very easily exerted.

### Eighth Embodiment

Now, description will be given of a method and device for image processing in accordance with an eighth embodiment of the present invention. The present embodiment relates to a fourth applied example of the graphic processors described in the first to fourth embodiments and exerts a soft shadow effect. The soft shadow effect means blurring of the contour of a shadow. In the actual world, few shadows made by a light source other than those which are very bright and directional like the sun have clear contours. Thus, the soft shadow effect makes it possible to improve the reality of computer graphics. This is particularly effective for scenes using indirect lighting.

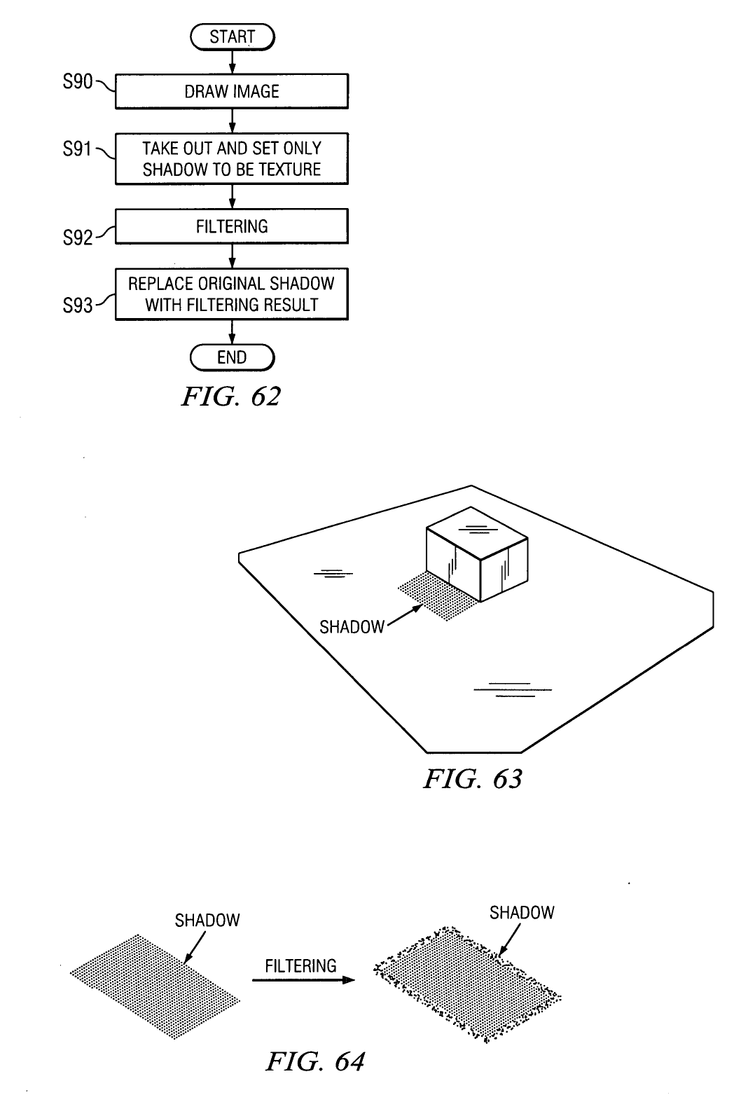

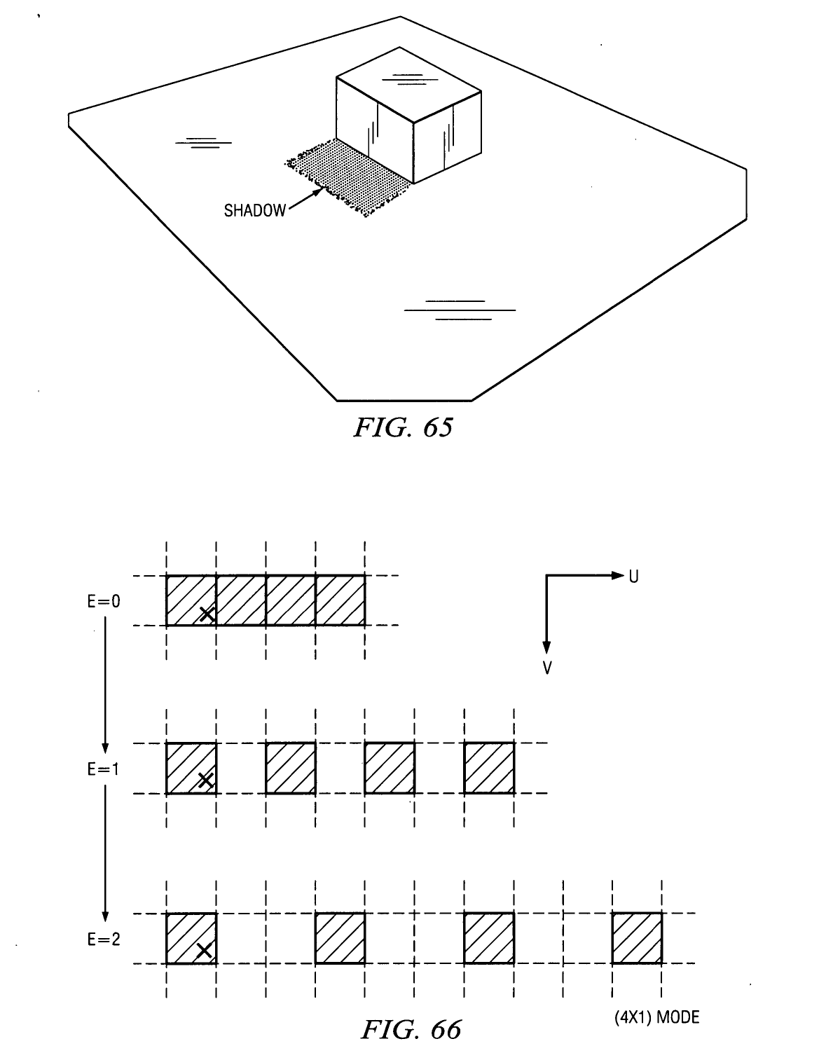

FIG. 62 is a flowchart of the soft shadow effect in accordance with the present embodiment. First, the pixel processing unit 6 draws an image and executes texture mapping as required (step S90). FIG. 63 shows the drawn image. At this time, the contour of a shadow in the image is clear. Then, only the shadow is taken out and set to be a texture image (step S91). A filtering process is then executed on the shadow set to be a texture image (step S92). The specific technique for executing a filtering process is as described in the above embodiments. However, not the entire shadow needs to be filtered but it is sufficient to filter only the contour of the shadow. This process is shown in FIG. 64. As shown in the figure, a shadow image with a blurred contour is obtained. Finally, the shadow obtained in step S92 is replaced with the original image (FIG. 63) (step S93). Then, as shown in FIG. 65, the contour of the shadow is blurred, resulting in an image with improved reality.

Thus, the above embodiments can also be used for the soft shadow effect.

### Ninth Embodiment

Now, description will be given of a method and device for image processing in accordance with a ninth embodiment of the present invention. The present embodiment relates to a fifth applied example of the graphic processors described in the first to fourth embodiments and relates to a method for acquiring texels.

A graphic processor in accordance with the present embodiment newly has a texel acquisition parameter E. The parameter E is provided to the texture unit 7 by the pixel processing unit 6 together with the acquisition mode. The coordinate calculation units 21-0 to 21-3 execute calculations using the acquisition mode, UV coordinates, and parameter E. The parameter E will be described. The parameter E is information indicating the distances between four texels to be acquired.

FIG. 66 shows the positional relationships among texels read when E=0, 1, or 2 in the (4×1) mode. Xs in the figure denote sampling points, and shaded squares denote texels to be read. As shown in the figure, for E=0, the distances between the texels are zero. For E=1, every other texels are read in the U axis direction. For E=2, every two texels are read in the U axis direction. That is, the coordinate calculation units 21-0 to 21-3 add the value of the parameter E to the adjacent texel to calculate the U coordinate. Specifically, as described with reference to FIG. 9, the coordinate calculation unit 21-0 calculates:
(s0=U, t0=v)
However, the coordinate calculation unit 21-1 calculates:
(s1=S0+E, t1=v)
The coordinate calculation unit 21-2 calculates:
(s2=S1+E, t2=v)
The coordinate calculation unit 21-3 calculates:
(s3=S2+E, t3=v)

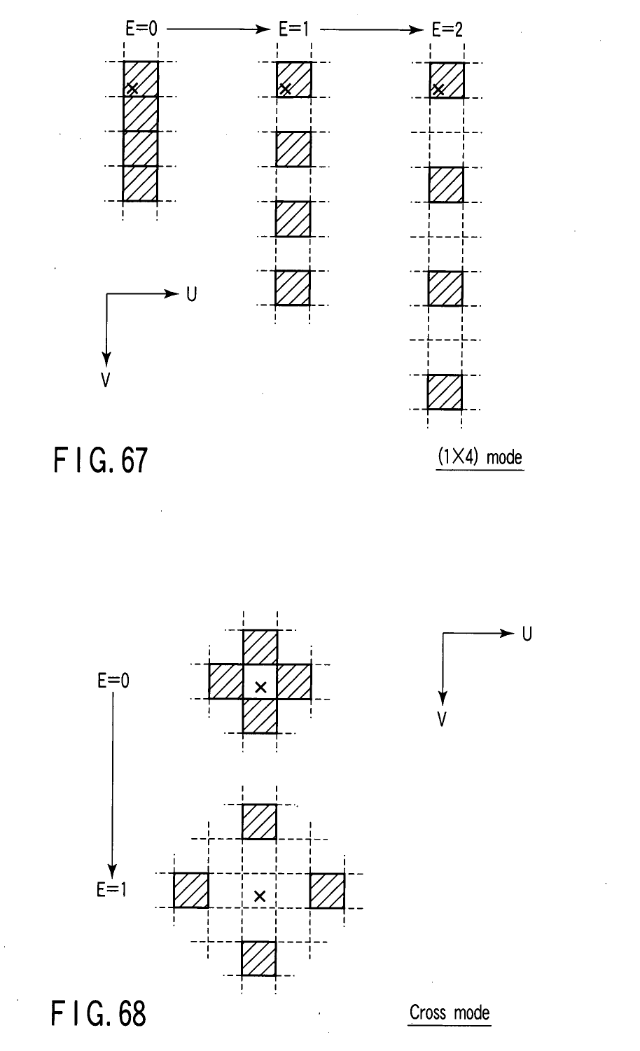

FIG. 67 shows the positional relationships among texels read when E=0, 1, or 2 in the (1×4) mode. The coordinate calculation unit 21-0 calculates:
(s0=U, t0=v)
However, the coordinate calculation unit 21-1 calculates:
(s1=u, t1=t0+E)
The coordinate calculation unit 21-2 calculates:
(s2=u, t2=t1+E)
The coordinate calculation unit 21-3 calculates:
(s3=u, t3=t2+E)

FIG. 68 shows the positional relationships among texels read when E=0, 1, or 2 in the cross mode. As shown in the figure, in the cross mode, the position of the read texel varies in both the U and V axis directions by a value corresponding to the parameter E. The coordinate calculation unit 21-0 calculates:
(s0=u, t0=v−1−E)
However, the coordinate calculation unit 21-1 calculates:
(s1=u−1−E t1=v)
The coordinate calculation unit 21-2 calculates:
(s2=u+1+E, t2=v)
The coordinate calculation unit 21-3 calculates:
(s3=u, t3=v+1+E)

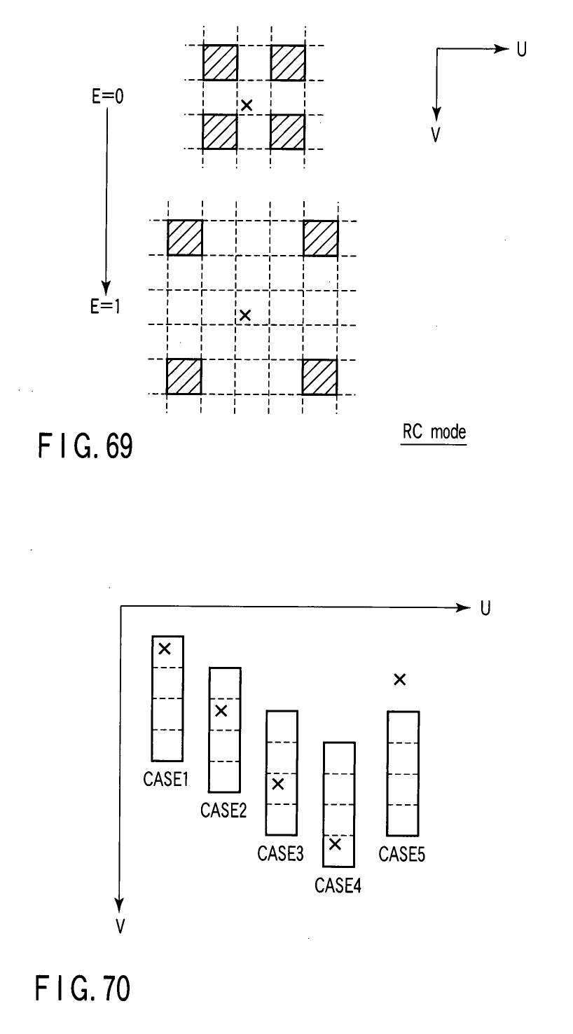

FIG. 69 shows the positional relationships among texels read when E=0, 1, or 2 in the RC mode. The coordinate calculation unit 21-0 calculates:
(s0=u−1−E, t0=v−1−E)
However, the coordinate calculation unit 21-1 calculates:
(s1=u−1−E, t1=v+1+E)
The coordinate calculation unit 21-2 calculates:
(s2=u+1+E, t2=v−1−E)
The coordinate calculation unit 21-3 calculates:
(s3=u+1+E, t3=v+1+E)

As described above, the parameter E makes it possible to vary the method for reading texels.

As described above, in the graphic processors in accordance with the first to ninth embodiments of the present invention, the pixel processing unit 6 provides the texture unit 7 with information indicating the texel acquisition mode. The texture unit 7 acquires texels in a pattern other than the (2×2) pattern in accordance with the acquisition mode. This drastically improves the degree of freedom of a texel filtering process. Further, the texture unit 7 receives an instruction on the repetition count from the pixel processing unit 6 and repeats a texel acquiring process that number of times. This enables a reduction in the load of texel acquisition on the pixel processing unit 6. Moreover, the interpolation coefficient enables more flexible image expressions.

In the description of the above embodiments, the (4×1) mode reads a texel corresponding to a sampling point and a set of three adjacent texels adjacent to the sampling point in the positive direction of the U axis, for example, as shown in FIG. 8. The (1×4) mode reads a texel corresponding to a sampling point and a set of three adjacent texels adjacent to the sampling point in the positive direction of the V axis. However, the positions of the four texels to be read are not limited to the above cases but may be appropriately set on the basis of the sampling point. FIG. 70 shows the relationship between four texels read in the (1×4) mode and sampling points; the texels and sampling points are plotted at UV coordinates. The Xs in the figure denote sampling points.

CASE 1 has been described in the above embodiments. CASE 2 shows that four texels are acquired on the basis of a position with a V coordinate different from that of the sampling point by −1. CASE 3 shows that four texels are acquired on the basis of a position with a V coordinate different from that of the sampling point by −2. CASE 4 shows that four texels are acquired on the basis of a position with a V coordinate different from that of the sampling point by −3. CASE 5 shows that four texels are acquired on the basis of a position with a V coordinate different from that of the sampling point by +1. In this case, the texel corresponding to the sampling point is not read. This also applies to the (4×1) mode.

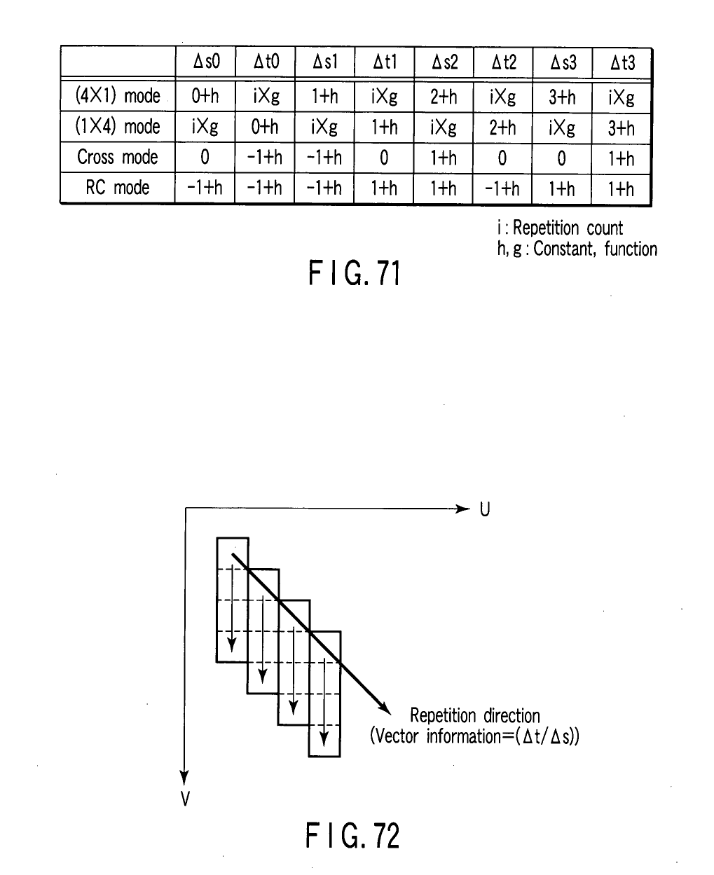

Further, the control unit 20 of the data acquisition unit 11 may have an offset table used to calculate coordinates. FIG. 71 is a conceptual diagram of the offset table. The offset table holds valuesΔs0 to Δs3 and Δt0 to Δt3 to be added to UV coordinates (u, v) corresponding to a sampling point when the coordinate calculation units 21-0 to 21-3 calculate coordinates. That is, the coordinate calculation units 21-0 to 21-3 read values from the offset table in the control unit 20 and execute the following calculations.
(s0, t0)=(u+Δs, 0v+Δt0)
(s1, t1)=(u+Δs1, v+Δt1)
(s2, t2)=(u+Δs2, v+Δt2)
(s3, t3)=(u+Δs3, v+Δt3)
In FIG. 71, i denotes a repetition count (counter value), and h and g denote constants, predetermined functions, or the like. By way of example, a case with the (1×4) mode will be described. In the (1×4) mode, the offset table holds Δs0=(i·g), Δt0=(0+h), Δs1=(i·g), Δt1=(1+h), Δs2=(I·g), Δt2=(2+h), Δs3=(i·g), and Δt3=(3+h). A case with h=0 corresponds to CASE 1 in FIG. 70. Cases with h=−1, −2, and −3 correspond to CASES 2 to 4 in FIG. 70, respectively. A case with h =1 corresponds to CASE 5 in FIG. 70. Further, for g =1, the U coordinate is incremented by +1 every time a texel is acquired. Setting g =2 increments the U coordinate by +2 and allows every other column of texels to be read. This also applies to the (4×1) mode. Information on the repetition count i may also be provided in the cross and RC modes.

Furthermore, in the description of the above embodiments, in the (4×1) mode, texel acquisition is repeated in the positive direction of the V axis. In the (1×4) mode, texel acquisition is repeated in the U axis direction. However, the present invention is not limited to this. FIG. 72 shows how a texel acquiring process is repeated; the texels are plotted at UV coordinates. As shown in the figure, both the U and V coordinates may vary for every repetition of the process. In this case, the pixel processing unit 6 has only to provide the texture unit 7 with vector information (Δt/Δs) that contributes to the process. On the basis of the vector information, the control unit 20 can update the offset table shown in FIG. 71.

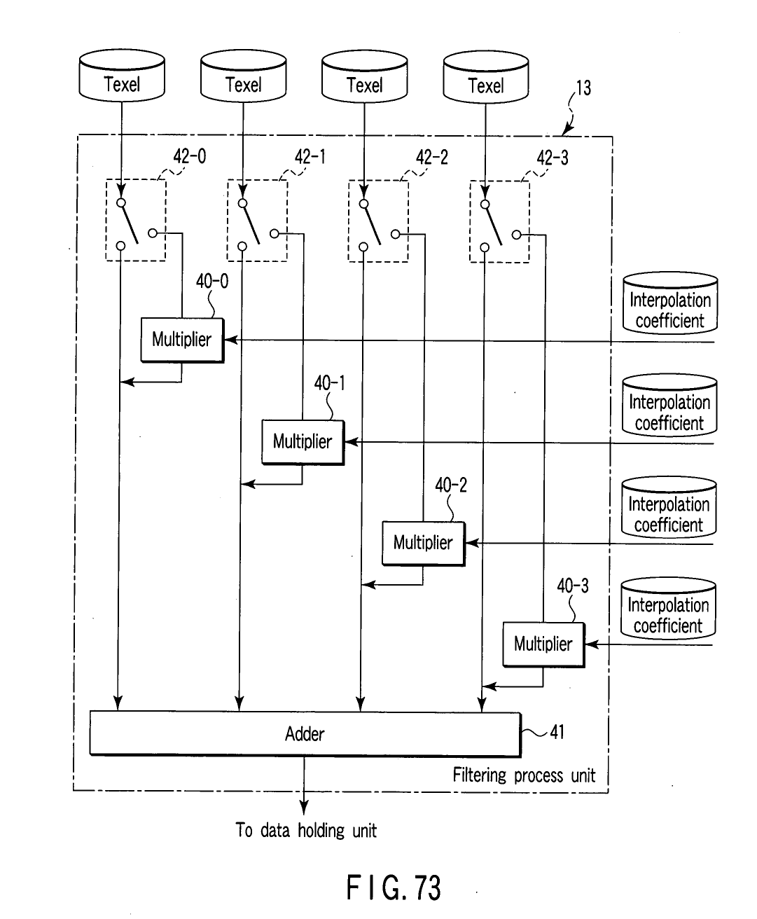

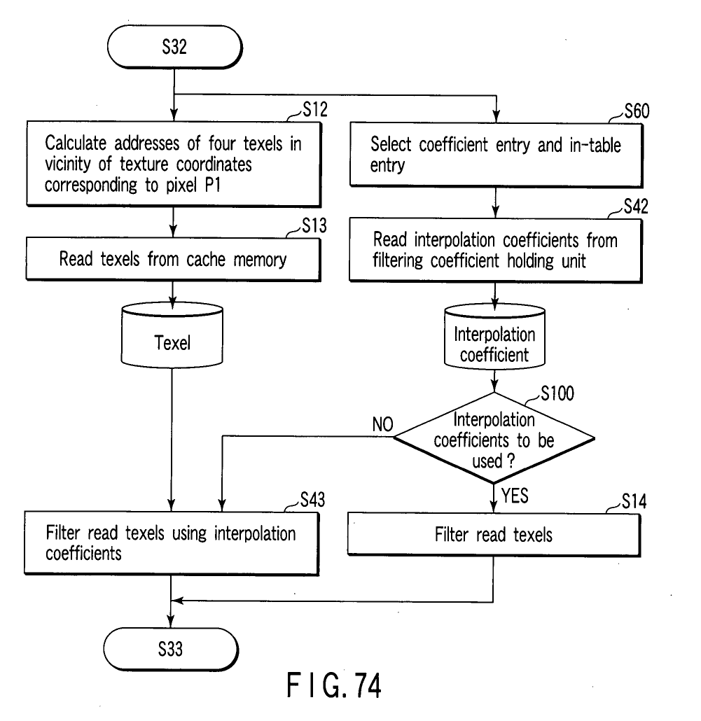

Moreover, in the third and fourth embodiments, whether or not to use interpolation coefficients can be freely determined. FIG. 73 is a block diagram of the filtering process unit 13 in accordance with a variation of the third and fourth embodiments. As shown in the figure, the filtering process unit 13 is configured as described with reference to FIG. 35 and further comprises switches 42-0 to 42-3. If interpolation coefficients are used, the switches 42-0 to 42-3 input texels acquired by the texel acquisition units 22-0 to 22-3 to the multipliers 40-0 to 40-3. If no interpolation coefficients are used, the switches 42-0 to 42-3 input the texels acquired by texel acquisition units 22-0 to 22-3, directly to the adder 41 without inputting them to the multipliers 40-0 to 40-3. FIG. 74 is a flowchart of the above process. As shown in the figure, after interpolation coefficients are acquired in step S42, whether or not to use them is determined (step S100). If the interpolation coefficients are to be used (step S100, YES), the process proceeds to step S43. If the interpolation coefficients are not to be used (step S100, NO), the processing in step S14 is executed and the process then proceeds to step S33.

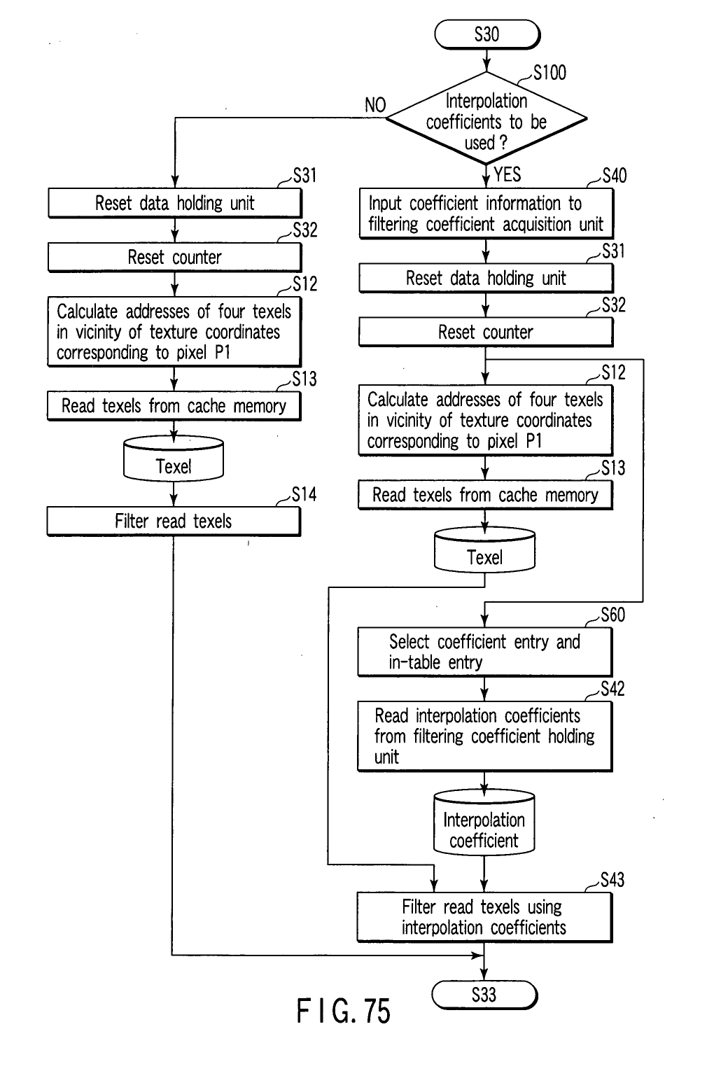

Alternatively, whether or not to use interpolation coefficients may be determined at the beginning of the process so as to avoid acquiring interpolation coefficients if they are not to be used. FIG. 75 is a flowchart of this case. As shown in the figure, the processing in the above step S100 is executed after step S30. Then, if interpolation coefficients are to be used (step S100, YES), the processing described in the fourth embodiment is executed. If no interpolation coefficients are to be used (step S100, NO), the process proceeds to step S31 instead of step S40 to execute the processing described in the second embodiment.

Moreover, in the description of the above embodiments, four texels are read at a time. However, less than four or at least five texels may be read. In this case, for example, the interpolation coefficient table shown in FIG. 33 holds the same number of interpolation coefficients as that of texels.

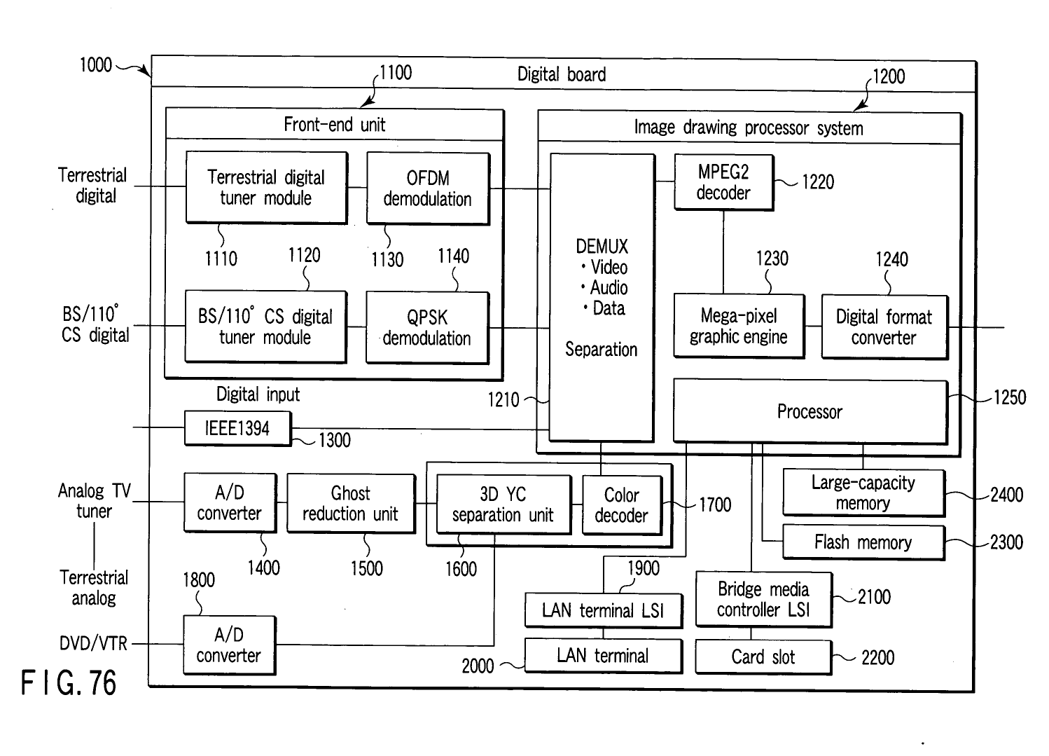

Furthermore, the graphic processors in accordance with the first to ninth embodiments can be mounted in, for example, game machines, home servers, televisions, mobile phone terminals, or the like. FIG. 76 is a block diagram of a digital board provided in a digital television including a graphic processor in accordance with any of the first to ninth embodiments. The digital board controls communication information such as images or sounds. As shown in FIG. 76, the digital board 1000 comprises a front-end unit 1100, an image drawing processor system 1200, a digital input unit 1300, A/D converters 1400 and 1800, a ghost reduction unit 1500, a 3D YC separation unit 1600, a color decoder 1700, a LAN terminal 1900, a LAN terminal 2000, a bridge media controller 2100, a card slot 2200, a flash memory 2300, and a large-capacity memory (for example, a DRAM) 2400. The front-end unit 1100 comprises digital tuner modules 1110 and 1120, an orthogonal frequency division multiplex (OFDM) demodulation unit 1130, and a quadrature phase shift keying (QPSK) demodulation unit 1140.

The image drawing processor system 1200 comprises a transmission and reception circuit 1210, an MPE2 decoder 1220, a graphic engine 1230, a digital format converter 1240, and a processor 1250. For example, the graphic engine 1230 corresponds to the graphic processor described in any of the first to ninth embodiments.

In the above configuration, terrestrial digital broadcasting, BS digital broadcasting, and 110° CS digital broadcasting are demodulated by the front-end unit 1100. Terrestrial analog broadcasting and DVD/VTR signals are decoded by the 3D YC separation unit 1600 and the color decoder 1700. These signals are input to the image drawing system 1200 and separated into videos, sounds, and data by the transmission and reception circuit 1210. For the videos, video information is input to the graphic engine 1230 via the MPEG2 decoder 1220. Then, the graphic engine 1230 draws a graphic ad described in the above embodiments.

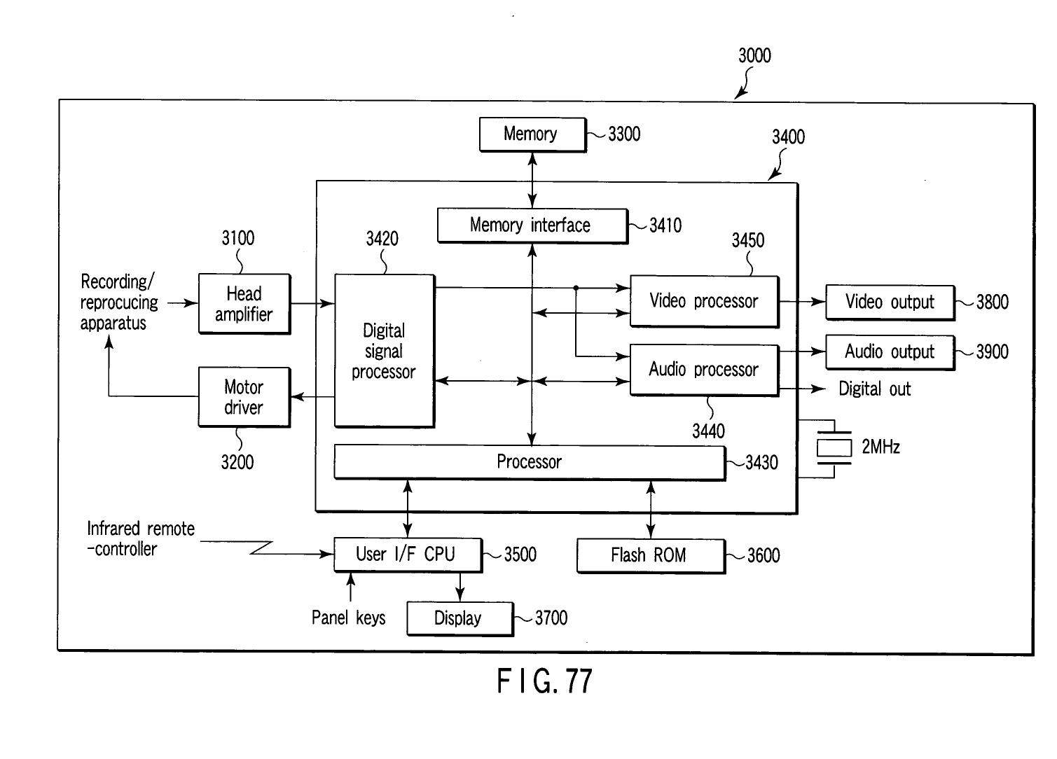

FIG. 77 is a block diagram of a recording/reproducing apparatus comprising the graphic processor in accordance with any of the first to ninth embodiments. As shown in the figure, the recording/reproducing apparatus 3000 comprises a head amplifier 3100, a motor driver 3200, a memory 3300, an image information control circuit 3400, a user I/F CPU 3500, a flash memory 3600, a display 3700, a video output unit 3800, and an audio output unit 3900.

The image information control circuit 3400 comprises a memory interface 3410, a digital signal processor 3420, a processor 3430, a video processor 3450, and an audio processor 3440. For example, the video processor 3450 and the digital signal processor 3420 correspond to the graphic processors in accordance with any of the first to ninth embodiments.

In the above configuration, video data read by the head amplifier 3100 is input to the image information control circuit 3400. The digital signal processor 3420 then inputs graphic information to the video information processor 3450. Then, the video information processor 3450 draws a graphic as described in the above embodiments.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for image processing comprising:
receiving a first coordinate in first image data which is a set of a plurality of first pixels, the first coordinate corresponding to a second coordinate in second image data which is a set of a plurality of second pixels, the second coordinate defining a mapping of the first pixels to one of the second pixels, and positional information indicative of a positional relationship among n (n is a natural number equal to or greater than 4) of the first pixels;
calculating an address of the first pixels corresponding to the first coordinate on the basis of the first coordinate and the positional information;
reading the first pixels from a first memory using the address; and
executing a filtering process on the first pixels read from the first memory to acquire a third pixel to be applied to one of the second pixels corresponding to the second coordinate.

2. The method according to claim 1, further comprising:
receiving a repetition count for the filtering process before calculating the address,
wherein the calculation of the address, the reading of the first pixels, and the acquisition of the third pixel are repeated a number of times equal to the repetition count,
in the calculation of the address, the address of the first pixels corresponding to the first coordinate to which an offset value has been added is calculated, and
the offset value varies every time the repetition is made.

3. The method according to claim 1, further comprising:
receiving interpolation coefficient information; and
reading interpolation coefficients used for the filtering process from a second memory on the basis of the interpolation coefficient information,
wherein the filtering process includes:
multiplying the interpolation coefficients read from the second memory by respective vector values for the first pixels read from the first memory; and
adding the multiplication results together to acquire the third pixel.

4. The method according to claim 1, further comprising:
receiving a repetition count for the filtering process before calculating the address;
receiving interpolation coefficient information;
reading interpolation coefficients used for the filtering process from a second memory on the basis of the interpolation coefficient information; and
repeating the calculation of the address, the reading of the first pixels, the reading of the interpolation coefficients, and the acquisition of the third pixel a number of times equal to the repetition count,
wherein in the calculation of the address, the address of the first pixels corresponding to the first coordinate to which an offset value has been added is calculated,
the offset value varies every time the repetition is made,
the interpolation coefficient read from the second memory varies every time the repetition is made, and
the filtering process includes:
multiplying the interpolation coefficients read from the second memory by respective vector values for the first pixels read from the first memory; and
adding the multiplication results together to acquire the third pixel.

5. The method according to claim 4, further comprising
executing the repetition based on the repetition count a number of times using different repetition counts;
receiving a depth value for the second coordinates; and
selecting the third pixel resulting from any of the repetition counts, in accordance with the depth value and applying the selected third pixel to one of the second pixels corresponding to the second coordinate.

6. The method according to claim 1, wherein the first image data is an MPEG image containing a plurality of blocks each of a set of a plurality of the first pixels, each of the blocks being compressed,
the first coordinate corresponds to a position of one of the first pixels located an end of one of the block, and
at least one of the first pixels corresponding to the first coordinate and the first pixels in a different block located adjacent to one of the first pixels corresponding to the first coordinate are read from the first memory.

7. The method according to claim 1, wherein an area in the second image data to which the third pixel is applied is an image containing a contour of a shadow of an object.

8. The method according to claim 1, further comprising:
before receiving the first coordinate and the positional information, setting, in the first image data, vector values for an (m×n) matrix (m is a natural number equal to or greater than 1) for each vertex of a polygon and setting elements of the matrix for the respective first pixels;
reading an (n×m) matrix of lighting coefficients for a light source for the polygon from a second memory; and
repeating the calculation of the address, the reading of the first pixels, the reading of the lighting coefficients, and the acquisition of the third pixel m times,
wherein in the calculation of the address, the address of the first address corresponding to the result of the addition of the first coordinates and an offset value is calculated,
the offset value increases by one within a range from 0 to (m−1) every time the repetition is made,
the filtering process includes:
multiplying the interpolation coefficients read from the second memory by respective vector values set for the first pixels read from the first memory; and
adding the multiplication results together to acquire the third pixel.

9. The method according to claim 8, wherein each row of the vector values includes parameters for a red component, a green component, a blue component, and a transparency of a corresponding vertex of the polygon, and each of the parameters is expanded to m dimensions.

10. An image processing device comprising:
a first memory which holds first image data which is a set of a plurality of first pixels;
an image data acquisition unit which reads the first pixels from the first memory, the image data acquisition unit reading a plurality of the first pixels on the basis of first coordinate in the first image data corresponding to a second coordinate in second image data which is a set of a plurality of second pixels, the second coordinate defining a mapping of the first pixels to one of the second pixels, and a positional relationship among n (n is a natural number equal to or greater than 4) of the first pixels corresponding to the first coordinate; and
a filtering process unit which executes a filtering process on the first pixels read from the first memory by the image data acquisition unit to acquire a third pixel.

11. The device according to claim 10, wherein the image data acquisition unit includes
a coordinate calculation unit which calculates coordinates, in the first image data, of n of the first pixels to be read on the basis of the first coordinate and the positional relationship; and
a first pixel acquisition unit which calculates addresses, in the first memory, of the n first pixels having the coordinates acquired by the coordinate calculation unit and which uses the addresses to read the first pixels from the first memory.

12. The device according to claim 11, wherein the coordinate calculation unit calculates the coordinates of (1×4) first pixels one of which has the first coordinate.

13. The device according to claim 11, wherein the coordinate calculation unit calculates the coordinates of (4×1) first pixels one of which has the first coordinate.

14. The device according to claim 11, wherein the coordinate calculation unit calculates the coordinates of two first pixels located opposite each other in a first direction across one of the first pixels having the first coordinate and of two first pixels located opposite each other in a second direction across one of the first pixels having the first coordinate.

15. The device according to claim 11, further comprising
a second memory which holds a plurality of interpolation coefficients used for the filtering process; and
a filtering coefficient acquisition unit which reads the interpolation coefficients from the second memory to output the interpolation coefficients to the filtering process unit.

16. The device according to claim 15, wherein the image data acquisition unit includes
a coordinate calculation unit which calculates coordinates, in the first image data, of n of the first pixels to be read on the basis of the first coordinate and the positional relationship; and
a first pixel acquisition unit which calculates addresses, in the first memory, of the n first pixels having the coordinates acquired by the coordinate calculation unit and which uses the addresses to read the first pixels from the first memory,
wherein the filtering coefficient acquisition unit includes
a coefficient selection unit which selects n of the interpolation coefficients to be applied to the n first pixels read by the image data acquisition unit; and
a coefficient acquisition unit which reads the interpolation coefficients selected by the coefficient selection unit from the second memory to output the read interpolation coefficients to the filtering process unit.

17. The device according to claim 16, wherein the filtering process unit includes
a multiplier which multiplies vector values for the n first pixels provided by the first pixel acquisition unit by the n interpolation coefficients provided by the coefficient acquisition unit; and
an adder which adds the multiplication results for the vector values for the first pixels together to acquire the third pixel.

18. The device according to claim 10, further comprising:
a counter which counts the number of times that the image data acquisition unit reads the first pixels; and
a control unit which instructs the image data acquisition unit to repeat reading the first pixels until the count in the counter reaches a predetermined set repetition count.
